(19) United States
(12) Patent Application Publication
(10) Pub. No.: US 2011/0228248 A1
(43) Pub. Date: Sep. 22, 2011

(54) COVER FOR A SUBSTRATE TABLE, SUBSTRATE TABLE FOR A LITHOGRAPHIC APPARATUS, LITHOGRAPHIC APPARATUS, AND DEVICE MANUFACTURING METHOD

(75) Inventors: Raymond Wilhelmus Louis Lafarre, Helmond (NL); Niek Jacobus Johannes Roset, Eindhoven (NL); Alexander Nikolov Zdravkov, Eindhoven (NL); Jan Willem Stouwdam, Best (NL); Bernardus Lambertus Johannes Bijl, Berlicum (NL)

(73) Assignee: ASML NETHERLANDS B.V., Veldhoven (NL)

(21) Appl. No.: 13/047,251

(22) Filed: Mar. 14, 2011

Related U.S. Application Data
(60) Provisional application No. 61/314,266, filed on Mar. 16, 2010.
(60) Provisional application No. 61/377,760, filed on Aug. 27, 2010.

(51) Int. Cl. G03B 27/58

(52) U.S. Cl. 355/72; 355/77

(57) ABSTRACT

A cover is provided for a substrate table in an immersion lithographic apparatus that covers at least the gap between a substrate and a recess in a substrate table in which the substrate is received.

This application claims priority and benefit under 35 U.S.C. §119(e) to U.S. Provisional Patent Application Ser. No. 61/314,266, entitled “Cover for a Substrate Table, Substrate Table for a Lithographic Apparatus, Lithographic Apparatus, and Device Manufacturing Method”, filed on Mar. 16, 2010, and to U.S. Provisional Patent Application Ser. No. 61/377,760, entitled “Cover for a Substrate Table, Substrate Table for a Lithographic Apparatus, Lithographic Apparatus, and Device Manufacturing Method”, filed on Aug. 27, 2010. The contents of those applications are incorporated herein in their entirety by reference.

### FIELD

The present invention relates to a cover for a substrate table, a substrate table for a lithographic apparatus, a lithographic apparatus and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another liquid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that should be accelerated during a scanning exposure. This may require additional or more powerful motors and turbulence in the liquid may lead to undesirable and unpredictable effects.

Other arrangements which have been proposed include a confined immersion system and an all wet immersion system. In a confined immersion system a liquid supply system provides liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504.

In an all wet immersion system, as disclosed in PCT patent application publication WO 2005/064405 the immersion liquid is unconfined. In such a system the whole top surface of the substrate is covered in liquid. This may be advantageous because then the whole top surface of the substrate is exposed to the substantially same conditions. This may have an advantage for temperature control and processing of the substrate. In WO 2005/064405, a liquid supply system provides liquid to the gap between the final element of the projection system and the substrate. Liquid is allowed to leak over the remainder of the substrate. A barrier at the edge of a substrate table prevents the liquid from escaping so that it can be removed from the top surface of the substrate table in a controlled way.

The immersion system may be a fluid handling system or apparatus. In an immersion system, immersion fluid is handled by a fluid handling system, structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. The fluid handling system may be located between the projection system and the substrate table. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

In a fluid handling system or liquid confinement structure, liquid is confined to a space, for example within a confinement structure. The space may be defined by the body of the confinement structure, the underlying surface (e.g. a substrate table, a substrate supported on the substrate table, a shutter member and/or a measurement table) and, in the case of a localized area immersion system, a liquid meniscus between the fluid handling system or liquid confinement structure and the underlying structure i.e. in an immersion space. In the case of an all wet system, liquid is allowed to flow out of the immersion space onto the top surface of the substrate and/or substrate table.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

After exposure of a substrate in an immersion lithographic apparatus, the substrate table is moved away from its exposure position to a position in which the substrate may be removed and replaced by a different substrate. This is known as substrate swap. In a two stage lithographic apparatus, for example ASML's “Twinscan” lithographic apparatus, the substrate tables swap takes place under the projection system.

### SUMMARY

In a lithographic apparatus, a substrate is supported on a substrate table by a substrate holder. The substrate holder may be located in a recess of the substrate table. The recess may be dimensioned so that when a substrate is supported by the substrate holder the top surface of the substrate is generally in the same plane as the surface of the substrate table surrounding the substrate. Around the substrate, there may be a gap between an edge of a substrate and an edge of the substrate table. Such a gap may be undesirable in an immersion system of a lithographic apparatus. As the gap moves under the immersion liquid in the space between the final element of the projection system and the underlying surface, the meniscus between the confinement structure and the underlying surface crosses the gap. Crossing the gap may increase the instability of the meniscus. The stability of the meniscus may decrease with increased relative speed, e.g. scanning or stepping speed, between the confinement structure and the substrate table. An increasingly unstable meniscus is a risk to increased defectivity. For example an unstable meniscus may enclose gas as a bubble in the immersion liquid, or may cause a droplet to escape from the immersion space. Such a bubble may be drawn into the space and result in imaging defects. A droplet may be a source of contaminants and a heat load as it evaporates and it may later collide with the meniscus causing a bubble to be drawn in to the space.

One or more problems of crossing the gap may be reduced by the provision of a two-phase extraction system. The two phase extraction system extracts fluid such as immersion liquid and gas (which may be present as a bubble in the liquid) from the gap. Sources of defectivity, such as releasing a bubble into the space or a droplet escaping from the space, may be reduced if not eliminated. However, the provision of such an extraction system may impart a heat load on the substrate table and the substrate. This may have a negative impact on the overlay accuracy of patterns formed on the substrate. The gap may implicitly limit the scan speed that may be used to achieve reliable imaging of a substrate.

It is therefore desirable to provide, for example, a system to increase the stability of the meniscus and reduce defectivity, for example the likelihood of creating a bubble or releasing a droplet.

In an aspect of an invention, there is provided a cover for use in a lithographic apparatus that includes a substrate table having a substantially planar upper surface in which is formed a recess that is configured to receive and support a substrate, the cover comprising a substantially planar main body that, in use, extends around the substrate from the upper surface to a peripheral section of an upper major face of the substrate in order to cover a gap between an edge of the recess and an edge of the substrate, the cover including a relatively flexible section which, in use, extends around the substrate, the relatively flexible section configured to have lower stiffness than the remainder of the cover.

In an aspect of an invention, there is provided a substrate table for a lithographic apparatus, the substrate table having a substantially planar upper surface in which is formed a recess that is configured to receive and support a substrate, the substrate table comprising:

a cover, configured such that, in use, it extends around the substrate from the upper surface to a peripheral section of an upper major face of the substrate in order to cover a gap between an edge of the recess and an edge of the substrate; an actuator system configured to move the cover between a closed position, in which the cover is in contact with the upper surface of a substrate supported in the recess, and an open position, in which the cover is set apart from a substrate in the recess; and

a controller configured to control the actuator system based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

In an aspect of an invention, there is provided a substrate table for a lithographic apparatus, the substrate table having a substantially planar upper surface in which is formed a recess that is configured to receive and support a substrate, the substrate table comprising:

a cover configured such that, in use, it extends around the substrate from the upper surface to a peripheral section of an upper major face of the substrate in order to cover a gap between an edge of the recess and an edge of the substrate; and

a support section within the recess configured to support the substrate within the recess, the support section configured such that a stiffness of the support section supporting the peripheral section of the substrate is greater than a stiffness of the support section supporting a central region of the substrate.

In an aspect of an invention, there is provided a method of loading a substrate to a substrate table of a lithographic apparatus, the substrate table having a substantially planar upper surface in which is formed a recess that is configured to receive and support the substrate, the method comprising:

loading a substrate to the recess; and

using an actuator system to move a cover to a position in which it extends around the substrate from the upper surface of the substrate table to a peripheral section of an upper major face of the substrate in order to cover a gap between an edge of the recess and an edge of the substrate,

wherein the actuator system is controlled based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

In an aspect of an invention, there is provided a substrate table for a lithographic apparatus, the substrate table having a substantially planar upper surface in which is formed a recess that is configured to receive and support a substrate, the substrate table comprising:

a cover, configured such that, in use, it extends around the substrate from the upper surface to a peripheral section of an upper major face of the substrate in order to cover a gap between an edge of the recess and an edge of the substrate; and

a support, configured to support the cover,

wherein the cover is releasably attached to the support.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a fluid handling structure as a liquid supply system for use in a lithographic projection apparatus;

FIG. 4 depicts a further liquid supply system for use in a lithographic projection apparatus;

FIG. 5 depicts, in cross-section, a liquid confinement structure which may be used in an embodiment of the present invention as a liquid supply system;

FIG. 6 depicts, in plan view, a substrate receiving section according to an aspect of the invention;

FIGS. 7 and 8 depict, in plan view, a cover according to an aspect of the invention in open and closed positions, respectively;

FIGS. 9 and 10 depict, in plan view, a cover according to an aspect of the invention in closed and open positions, respectively;

FIGS. 11, 12 and 13 depict, in cross-section, an actuator system for a cover according to an aspect of the invention in, respectively, the closed position, an intermediate position and the open position;

FIGS. 14 and 15 depict, in cross-section, an arrangement of movement guides that may be used in an actuator system of an aspect of the invention;

FIGS. 16, 17 and 18 depict an actuator system for a cover according to an aspect of the invention in, respectively, a closed position, an intermediate position and an open position;

FIG. 19 depicts, in cross-section, an arrangement of a cover according to an aspect of the invention;

FIGS. 20 and 21 depict, in cross-section, a cover according to an aspect of the invention;

FIG. 22 depicts, in cross-section, an arrangement of a cover according to an aspect of the invention;

FIGS. 23 to 26 schematically depict possible configurations of the edge of a cover according to an aspect of the invention;

FIG. 27 schematically depicts a control system for an actuator system to move a cover according to an aspect of the invention;

FIGS. 28 to 34 schematically depict, in cross section, arrangements of covers according to an aspect of the invention;

FIGS. 35 and 36 depict arrangements of support sections of substrate tables according to an aspect of the invention;

FIG. 37 depicts an arrangement to releasably connect a cover to a support;

FIG. 38 depicts a further arrangement to releasably connect a cover to a support;

FIG. 39 depicts a further arrangement to releasably connect a cover to a support;

FIG. 40 depicts an arrangement to releasably connect a cover and a support to an actuator system;

FIG. 41 depicts an arrangement to releasably connect a cover, a support and a lateral actuator stage to a transverse actuator stage; and

FIG. 42 depicts an arrangement to releasably connect a cover, a support, a lateral actuator stage and a transverse actuator stage to a substrate table.

### DETAILED DESCRIPTION

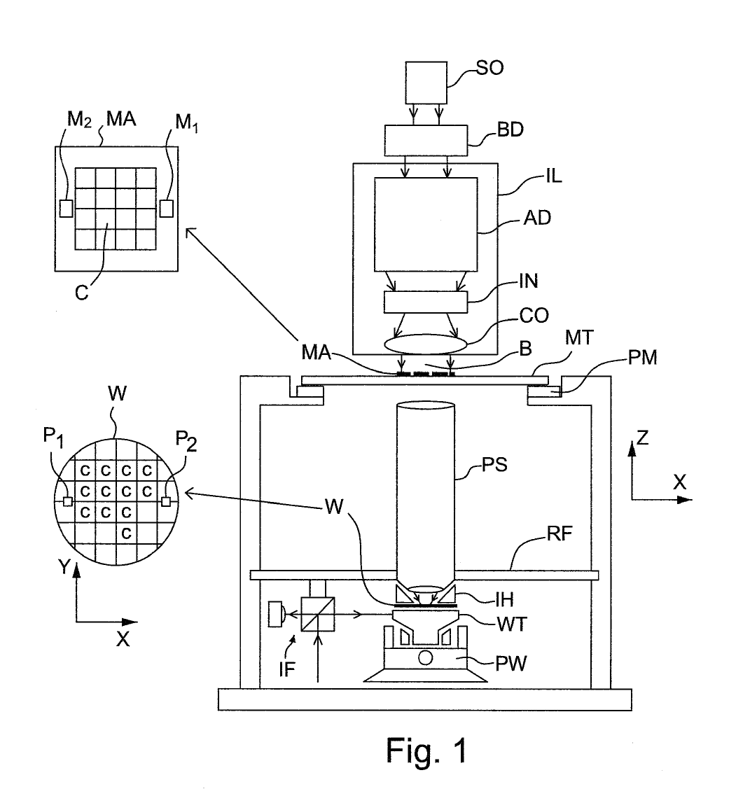

FIG. 1 schematically depicts a lithographic apparatus according to one embodiment of the invention. The apparatus comprises:
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device MA in accordance with certain parameters;
a substrate table (e.g. a wafer table) WT constructed to hold a substrate (e.g. a resist-coated wafer) W and connected to a second positioner PW configured to accurately position the substrate W in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. The support structure MT holds the patterning device MA in a manner that depends on the orientation of the patterning device MA, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as desired. The support structure MT may ensure that the patterning device MA is at a desired position, for example with respect to the projection system PS. Any use of the Willis “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. The types of projection system may include: refractive, reflective, catadioptric, magnetic, electromagnetic and electrostatic optical systems, or any combination thereof. The selection or combination of the projection system is as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS. The projection system PS focuses the beam B onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

In another mode, the support structure MT is kept essentially stationary holding a programmable patterning device, and the substrate table WT is moved or scanned while a pattern imparted to the radiation beam B is projected onto a target portion C. In this mode, generally a pulsed radiation source is employed and the programmable patterning device is updated as desired after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

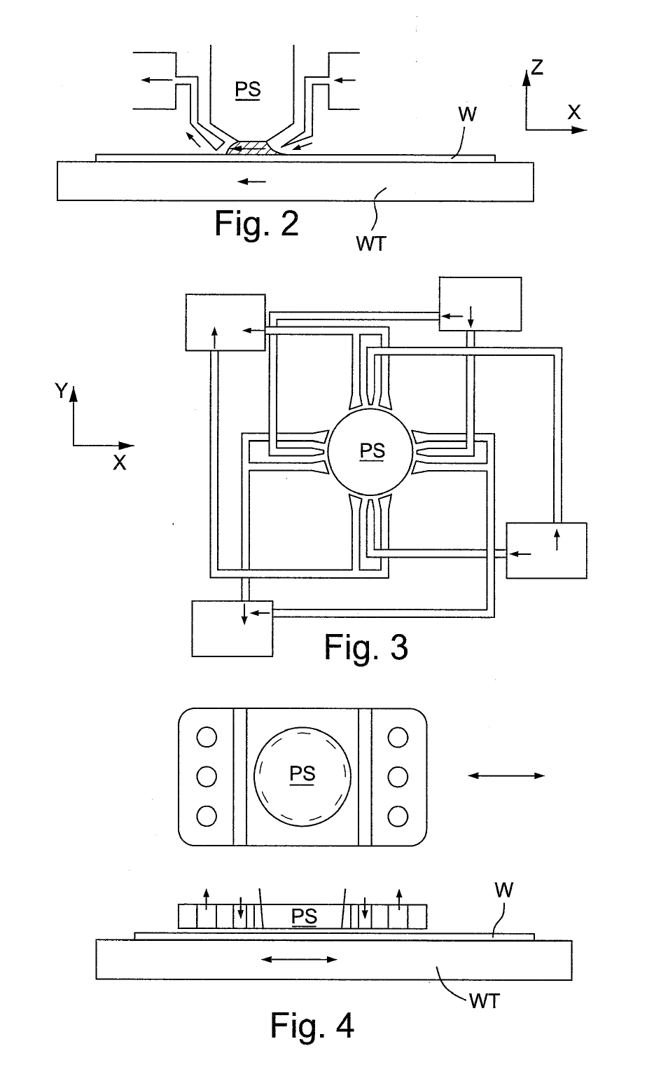

An arrangement to provide liquid between a final element of the projection system PS and the substrate is the so called localized immersion system IH. In this system a liquid handling system is used in which liquid is only provided to a localized area of the substrate. The space filled by liquid is smaller in plan than the top surface of the substrate and the area filled with liquid remains substantially stationary relative to the projection system PS while the substrate W moves underneath that area. Four different types of localized liquid supply systems are illustrated in FIGS. 2-5.

As illustrated in FIGS. 2 and 3, liquid is supplied by at least one inlet onto the substrate, preferably along the direction of movement of the substrate relative to the final element. Liquid is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. In the illustration of FIG. 2 the liquid is supplied along the direction of movement of the substrate relative to the final element, though this does not need to be the case. Various orientations and numbers of in- and out-lets positioned around the final element are possible; one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets can be arranged in a plate with a hole in its centre and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in inlets and out of outlets.

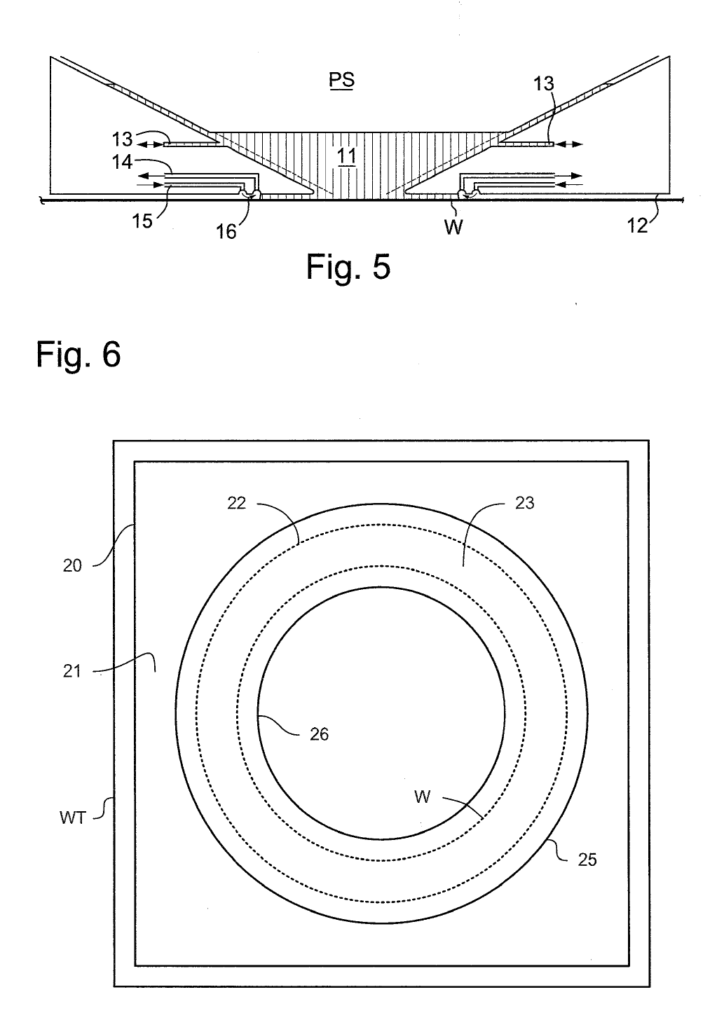

Another arrangement which has been proposed is to provide the liquid supply system with a liquid confinement member which extends along at least a part of a boundary of the space between the final element of the projection system and the substrate table. Such an arrangement is illustrated in FIG. 5. The liquid confinement member is substantially stationary relative to the projection system in the XY plane though there may be some relative movement in the Z direction (in the direction of the optical axis). A seal is formed between the liquid confinement and the surface of the substrate. In an embodiment, a seal is formed between the liquid confinement structure and the surface of the substrate and may be a contactless seal such as a gas seal. Such a system is disclosed in United States patent application publication no. US 2004-0207824, hereby incorporated in its entirety by reference.

FIG. 5 schematically depicts a localized liquid supply system with a liquid confinement structure 12. The liquid confinement structure 12 extends along at least a part of a boundary of the space 11 between the final element of the projection system PS and the substrate table WT or substrate W. (Please note that reference in the following text to surface of the substrate W also refers in addition or in the alternative to a surface of the substrate table WT, unless expressly stated otherwise.) The liquid confinement structure 12 is substantially stationary relative to the projection system PS in the XY plane though there may be some relative movement in the Z direction (in the direction of the optical axis). In an embodiment, a seal is formed between the liquid confinement structure 12 and the surface of the substrate W and may be a contactless seal such as fluid seal, desirably a gas seal.

The liquid confinement structure 12 at least partly contains liquid in the immersion space 11 between a final element of the projection system PS and the substrate W. A contactless seal 16 to the substrate W may be formed around the image field of the projection system PS so that liquid is confined within the space 11 between the substrate W surface and the final element of the projection system PS. The immersion space 11 is at least partly formed by the liquid confinement structure 12 positioned below and surrounding the final element of the projection system PS. Liquid is brought into the space 11 below the projection system PS and within the liquid confinement structure 12 by liquid inlet 13. The liquid may be removed by liquid outlet 13. The liquid confinement structure 12 may extend a little above the final element of the projection system PS. The liquid level rises above the final element so that a buffer of liquid is provided. In an embodiment, the liquid confinement structure 12 has an inner periphery that at the upper end closely conforms to the shape of the projection system PS or the final element thereof and may, e.g., be round. At the bottom, the inner periphery closely conforms to the shape of the image field, e.g., rectangular, though this need not be the case.

In an embodiment, the liquid is contained in the immersion space 11 by a gas seal 16 which, during use, is formed between the bottom of the liquid confinement structure 12 and the surface of the substrate W. Other types of seal are possible, as is no seal (for example in an all wet embodiment) or a seal achieved by capillary forces between the undersurface of the liquid confinement structure 12 and a facing surface, such as the surface of a substrate W, a substrate table WT or a combination of both.

The gas seal 16 is formed by gas, e.g. air or synthetic air but, in an embodiment, N₂ or another inert gas. The gas in the gas seal 16 is provided under pressure via inlet 15 to the gap between liquid confinement structure 12 and substrate W. The gas is extracted via outlet 14. The overpressure on the gas inlet 15, vacuum level on the outlet 14 and geometry of the gap are arranged so that there is a high-velocity gas flow inwardly that confines the liquid. The force of the gas on the liquid between the liquid confinement structure 12 and the substrate W contains the liquid in an immersion space 11. The inlets/outlets may be annular grooves which surround the space 11. The annular grooves may be continuous or discontinuous. The flow of gas is effective to contain the liquid in the space 11. Such a system is disclosed in United States patent application publication no. US 2004-0207824.

Other arrangements are possible and, as will be clear from the description below, an embodiment of the present invention may use any type of localized immersion system.

In a localized immersion system a seal is formed between a part of the liquid confinement structure and an underlying surface, such as a surface of a substrate W and/or substrate table WT. The seal may be defined by a meniscus of liquid between the liquid confinement structure and the underlying surface. Relative movement between the underlying surface and the liquid confinement structure may lead to breakdown of the seal, for example the meniscus, above a critical speed. Above the critical speed, the seal may break down allowing liquid, e.g. in the form of a droplet, to escape from the liquid confinement structure, or gas, i.e. in the form of a bubble, to be enclosed in the immersion liquid within the immersion space.

A droplet may be a source of defectivity. The droplet may apply a thermal load on the surface which it is located as it evaporates. The droplet may be a source of contamination, in leaving a drying stain after it has evaporated. If the droplet lies in the path on the underlying surface which moves under the projection system, the droplet may contact the meniscus. The resulting collision between the meniscus and the droplet may cause a bubble to form in the liquid. A bubble may be a source of defectivity. A bubble in the immersion liquid may be drawn in to the space between the projection system and the substrate where it may interfere with an imaging projection beam.

Critical speed may be determined by the properties of the underlying surface. The critical speed of a gap relative to the confinement structure may be less than the critical speed for the surface of a relatively planar surface such as a substrate. On increasing the scan velocity above the lowest critical speed for a part of the undersurface, the scan velocity will exceed the critical speed for more of the underlying surface. The problem may be more significant at high scan velocities. However, an increased scan velocity is desirable because throughput increases.

FIG. 6 depicts, in plan view, a substrate table WT that may be used to support a substrate W. The substrate table may have a substantially planar upper surface 21. In the upper surface 21 is a recess 22 that is configured to receive and support a substrate W.

In the recess may be a substrate support which may be a surface of the recess. The surface of the recess 22 may include a plurality of protrusions on which a lower surface of the substrate is supported. The surface of the recess may include a barrier. In the surface of the recess may be formed a plurality of openings. The barrier surrounds the protrusions to define a space beneath the lower surface of the substrate W. The openings are connected to an under-pressure source. When a substrate is located above the openings a space is formed beneath the substrate W. The space may be evacuated by operation of the underpressure. This arrangement may be used in order to secure the substrate W to the substrate table WT.

In an arrangement, the recess may be configured such that the major faces of the substrate, namely the upper face and the lower face, are substantially parallel to the upper surface 21 of the substrate table. In an arrangement, the upper face of the substrate W may be arranged to be substantially coplanar with upper surface 21 of the substrate table.

It should be appreciated that in the present application, terms such as upper and lower may be used in order to define the relative positions of components within the systems described. However, these terms are used for convenience in order to describe the relative positions of the components when the apparatus is used at a particular orientation. They are not intended to specify the orientation in which the apparatus may be used.

As depicted in FIG. 6, a gap 23 may be present between an edge of the substrate W and an edge of the recess 22. According to an aspect of the invention, a cover 25 is provided that extends around the substrate W. The cover 25 extends from a peripheral section of the upper surface of the substrate W (which in an embodiment may be an edge of the substrate) to the upper surface 21 of the substrate table WT. The cover 25 may entirely cover the gap 23 between the edge of the substrate W and the edge of the recess 22. In addition, an open central section 26 of the cover 25 may be defined by an inner edge of the cover. The open central section 26 may be arranged such that, in use, the cover 25 does not cover portions of the substrate W on which it is intended to project a patterned beam of radiation. The inner edge of the cover may cover portions of the substrate which neighbor the surface of the substrate which is imaged by the patterned projection beam. The cover is located away from those portions of the substrate which are exposed by the patterned projection beam.

As shown in FIG. 6, when the cover 25 is placed on the substrate W, the size of the open central section 26 may be slightly smaller than the size of the upper surface of the substrate W. As shown in FIG. 6, if the substrate W is circular in shape, the cover 25 may be generally annular in shape when viewed in plan view.

The cover 25 may be in the form of a thin cover plate. The cover plate may, for example, be formed from stainless steel. Other material may be used. The cover plate may be coated with Lipocer coating of the type offered by Plasma Electronic GmbH. Lipocer is a coating which may be lyophobic (e.g. hydrophobic) and is relatively resistant to damage from exposure to radiation and immersion liquid (which may be highly corrosive). More information on Lipocer may be found in U.S. Patent Application Publication No. US 2009/02066304, which is hereby incorporated by reference in its entirety.

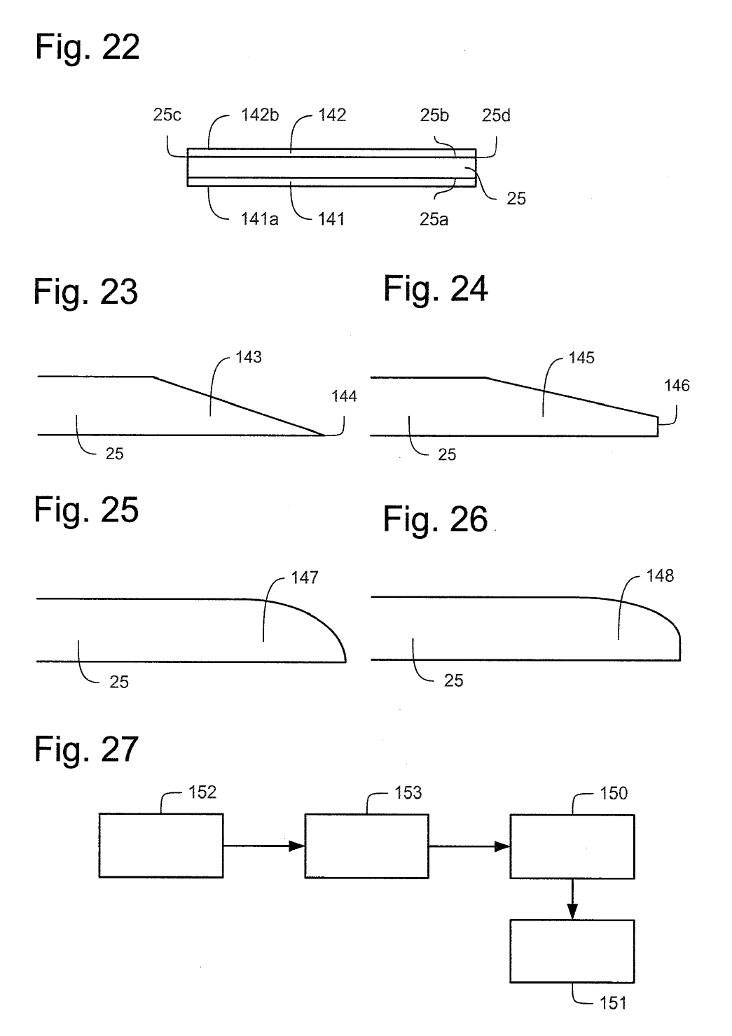

As schematically depicted in FIG. 22, a lyophobic coating 141, such as a layer of Lipocer, may be applied to the lower surface 25a of the cover 25, namely the surface, that in use, may extend from a peripheral section of the upper surface of the substrate W to the upper surface 21 of the substrate table WT. The provision of such a coating 141 on the lower surface 25a may minimize or reduce the leakage of immersion liquid below the cover 25. For example, the coating 141 may reduce the leakage of immersion liquid between the cover 25 and the upper surface of the substrate W. Minimizing or reducing such immersion liquid leakage may in turn reduce the likelihood of immersion liquid being passed to the underside of the substrate W. This may reduce defects that may be introduced as a result of the so-called back side contamination. Minimizing or reducing immersion liquid leakage may reduce a thermal load on the substrate W.

The coating 141 on the lower surface 25a of the cover 25 may be selected to be an anti-sticking layer. In other words, the coating 141 may be selected to prevent, minimize or reduce adhesion of the cover 25 to the upper surface of the substrate W and/or the upper surface 21 of the substrate table WT. This may prevent or reduce damage to the cover 25, the substrate W and/or the substrate table WT when the cover 25 is removed from the substrate W and the substrate table WT.

The use of a coating 141 on the lower surface 25a of the cover 25 that is lyophobic and/or anti-sticking may prevent or reduce the accumulation of contamination particles on the lower surface of the cover 25. Such contaminant particles could result in damage to any of the cover 25, the substrate W and/or the substrate table WT or provide a source of subsequent defects on the substrate W. Alternatively or additionally, such contaminant particles may prevent a sufficient seal being formed between the cover 25 and the upper surface of the substrate W and/or the upper surface 21 of the substrate table WT, resulting in leakage of the immersion liquid, which may be undesirable. Accordingly, it may be desirable to prevent the accumulation of such contaminant particles.

The lower surface 25a of the cover 25 and/or the lower surface 141a of a coating 141 applied to the lower surface 25a of the cover 25 may be configured to have low surface roughness. For example, for a spray coating, the surface roughness R_{A} may be less than 1 μm. For a deposited coating the surface roughness R_{A} may be less than 200 nm. In general, reducing the surface roughness of the lower surface 25a of the cover and/or the lower surface 141a of a coating 141 applied to the lower surface 25a of the cover 25 may reduce stress concentrations on the surface of the substrate W. The surface roughness R_{A} of parts of the cover 25 in contact with the substrate in use may desirably be less than 200 nm, desirably less than 50 nm, or desirably less than 10 nm.

Ensuring that the surface roughness of the lower surface 25a of the cover 25 and/or the lower surface 141a of a coating 141 applied to the lower surface 25a of the cover 25 is low may also assist in reducing or minimizing leakage of immersion liquid below the cover 25. The cover 25 may be arranged such that the flatness of the lower surface 25a of the cover 25 and/or the lower surface 141a of a coating 141 applied to the lower surface 25a of the cover 25 is maximized. This may provide optimized contact between the cover 25 and the substrate W and/or the substrate table WT, reducing or minimizing immersion liquid leakage.

As schematically depicted in FIG. 22, a coating 142 may alternatively or additionally be provided on the upper surface 25b of the cover 25. The upper surface 25b of the cover 25 or the upper surface 142b of a coating 142 on the upper surface 25b of the cover may be selected for smoothness. This may reduce the likelihood of the meniscus being pinned. For example, the upper surface 25b of the cover 25 or the upper surface 142b of a coating 142 on the upper surface 25b of the cover may be smooth such that the peak to valley distance of the surface is less than 10 μm, desirably less than 5 μm.

The coating 142 on the upper surface 25b of the cover 25 may be selected to be resistant to damage from exposure to radiation and immersion liquid. This may help ensure that the working life of the cover is sufficiently long to prevent unnecessary costs associated with replacing the cover 25, including downtime for the lithographic apparatus. The coating 142 on the upper surface 25b of the cover 25 may be selected to be lyophobic, as discussed above. Such a coating may provide a higher receding contact angle for the immersion liquid. This in turn may permit a higher scan speed to be used without, for example, the loss of immersion liquid from the meniscus, as discussed above. As noted above, the coating 142 on the upper surface 25b of the cover 25 may be fowled from Lipocer.

It should be appreciated that the coatings 141, 142 on the lower and upper surface 25a, 25b of the cover 25 may be formed from the single layer of material. Alternatively, one or both of the coatings 141, 142 may be formed from a plurality of layers. For example, the layers may be formed from different materials, providing different benefits to the coating 141, 142. It should also be appreciated that the coatings 141, 142 on the lower and upper surfaces 25a, 25b of the cover 25 may be the same or different from each other.

The cover plate may, for example, be 25 μm thick. It may be etched to be locally reduced in thickness, for example at one or more of the edges. In a locally reduced area it may be 10 μm thick. The thickness of part of the cover may be reduced by other processes such as laser ablation, milling and polishing.

As depicted in FIG. 22, the edges 25c, 25d of the cover 25, namely the edges separating the lower and upper surfaces 25a, 25b of the cover 25 may be substantially perpendicular to the lower and upper surfaces 25a, 25b of the cover 25. Such an arrangement may be relatively simple to manufacture.

However, in an arrangement as depicted in FIG. 22, the edges 25c, 25d of the cover 25 may form a step on the surface of the substrate W and the upper surface 21 of the substrate table WT. Such a step may be undesirable. In particular, as discussed above, when the substrate W and substrate table WT move relative to the liquid confinement structure, care must be taken to ensure that the seal formed by a meniscus of liquid between the liquid confinement structure and the substrate W and/or substrate table WT does not break down. The introduction of a step on the surface may reduce the critical speed between the liquid confinement structure and the substrate W and/or substrate table WT up to which the liquid confinement structure and/or the substrate W/substrate table WT may move without the seal, for example the meniscus, breaking down.

One or more of the edges 25c, 25d of the cover 25 may be configured to provide a reduced step. For example, as discussed above, the thickness of the cover may be locally reduced at one or more of the edges. For example, one or more of the edges 25c, 25d of the cover may be configured to have a profile as schematically depicted in any one of FIGS. 23 to 26.

As depicted in FIG. 23, an edge of the cover 25 may be configured to have a section 143 in which the cover 25 tapers to a point. Accordingly, such a cover may have no step. However, the extreme edge of the cover 25 may be susceptible to damage.

In an alternative arrangement, as depicted in FIG. 24, the cover 25 may have an edge section 145 that includes a step 146 that is smaller than the thickness of the cover 25 and a tapered section between the step 146 and the main body of the cover 25 that has the full thickness. For example, the main body of the cover 25 may be 25 μm thick and the step 146 may be 10 μm thick. Such an arrangement has a smaller step than a cover that has a perpendicular edge 25c, 25d but may be less susceptible to edge damage than an arrangement as depicted in FIG. 23.

As depicted in FIGS. 23 and 24, the tapered section 143, 145 of the edge of a cover 25 may be configured to linearly increase in thickness relative to the distance from the edge. However, this is not essential. As depicted in FIGS. 25 and 26, which correspond to FIGS. 23 and 24, respectively, the tapered sections 147, 148 may be curved instead. This may avoid the provision of sharp corners, for example between the tapered section and the remainder of the cover 25 or between the tapered section and a reduced step at the edge of the cover 25. Such sharp corners may be a source of instability in the seal, for example the meniscus, between the liquid confinement structure and the underlying surface. Accordingly, avoiding such sharp corners may reduce the likelihood of droplets being lost from the meniscus, reducing possible defectivity as discussed above.

As shown in FIGS. 23 to 26, the lower corner of the cover 25, namely the corner that in use may be in contact with the upper surface of the substrate W and/or the substrate table WT, may be a relatively sharp corner. This may provide a relatively good seal between the cover 25 and the substrate W and/or substrate table WT. However, it should be appreciated that the lower corner may be curved instead. This may reduce the likelihood of damage to the substrate W.

In general avoiding sharp corners on the cover may facilitate the provision of a coating on the cover 25, if desired.

It should be appreciated that, although FIGS. 23 to 26 depict one edge of a cover 25 with a tapered section and/or a rounded, one or more the edges of the cover 25 may be tapered and/or have one or more rounded corners as discussed above. Furthermore, the edges of a cover 25 may have a different respective arrangements of a tapered section and/or rounded corners.

In an embodiment, the upper surface 25b of the cover 25 or the upper surface 142b of a coating 142 on the upper surface 25b of the cover 25 may be configured to be as flat as possible. This may further reduce any instabilities of the meniscus discussed above, reducing the likelihood of droplets being lost from the meniscus and subsequent defects as discussed above.

In an embodiment, the cover may be a part of the substrate table. An actuator system may be provided to move the cover between at least closed and open positions. In the closed position, the cover 25 may be in contact with the upper surface of a substrate W within the recess 22. In the closed position, the cover 25 may be in contact with the upper surface 21 of the substrate table WT. In the closed position, the cover 25 may cover the gap 23 between the edge of the substrate W and the edge of the recess 22.

The cover 25 may be configured so that, as the gap passes underneath the immersion space 11, with respect to the immersion liquid in the space, the gap is closed. By closing the gap, the stability of the meniscus in crossing the gap may be improved. In an embodiment, the cover forms a seal with one or both of the upper surface of a substrate W within the recess 22 and the upper surface 21 of the substrate table WT. A cover 25 that provides a seal with both the upper surface of the substrate W and the upper surface 21 of the substrate table WT may prevent immersion liquid from passing into the gap 23. The cover may reduce the inflow of immersion liquid into the gap 23. The cover may help reduce, if not prevent, the flow of bubbles into the space 11 as a consequence of the gap passing underneath the space 11.

In the open position, the cover 25 may be moved away from its location at the closed position relative to the surface of the recess 22. When a substrate is supported by the surface of the recess 22, the cover 25 may be set apart from the substrate W. The open position may be arranged such that, when the cover 25 is in the open position, the substrate W may be unloaded from the substrate table WT. If a substrate W is not present in the recess 22, a substrate W may be loaded onto the substrate table WT.

In an embodiment, the actuator system may be configured such that, in moving the cover 25 from the closed position to the open position, it enlarges the open central section 26 of the cover 25, as depicted in FIG. 8. In such a process, the open central section 26 of the cover 25 may be enlarged sufficiently that the open central section 26 is larger than the upper surface of the substrate W in the open position. The open central section 26 of the cover 25 may be enlarged sufficiently for the substrate W to be able to pass through the central open section 26 of the cover 25.

In an embodiment, a substrate W may be loaded onto, or unloaded from, a substrate table by moving the cover 25 to the open position and passing the substrate W through the central open portion 26 of the cover 25. In the case of loading a substrate W to a substrate table WT, once the substrate W has passed through the open central section 26 of the cover 25, the substrate W may be received in the recess 22 of the substrate table WT. Subsequently, the cover 25 may be moved by the actuator system to the closed position, in which it covers the gap 23 between the edge of the substrate W and the edge of the recess 22 in which the substrate W is supported.

The actuator system may be configured such that, in moving the cover 25 to the open position, a plurality of portions of the cover 25 are moved in different respective directions relative to each other. This arrangement may be used in order to enlarge the open central section 26 of the cover 25 in moving to the open position. For example, the actuator system may be configured such that it may move each of the portions of the cover 25 in a respective direction. The respective direction may be away from the open central section 26 when moving the cover to the open position.

In an embodiment, the actuator system may be configured to elastically deform at least a part of the cover 25. For example, the actuator system may elastically deform at least part of the cover 25 when the actuator moves the plurality of portions of the cover 25 in respective different directions in order to enlarge the open central section 26.

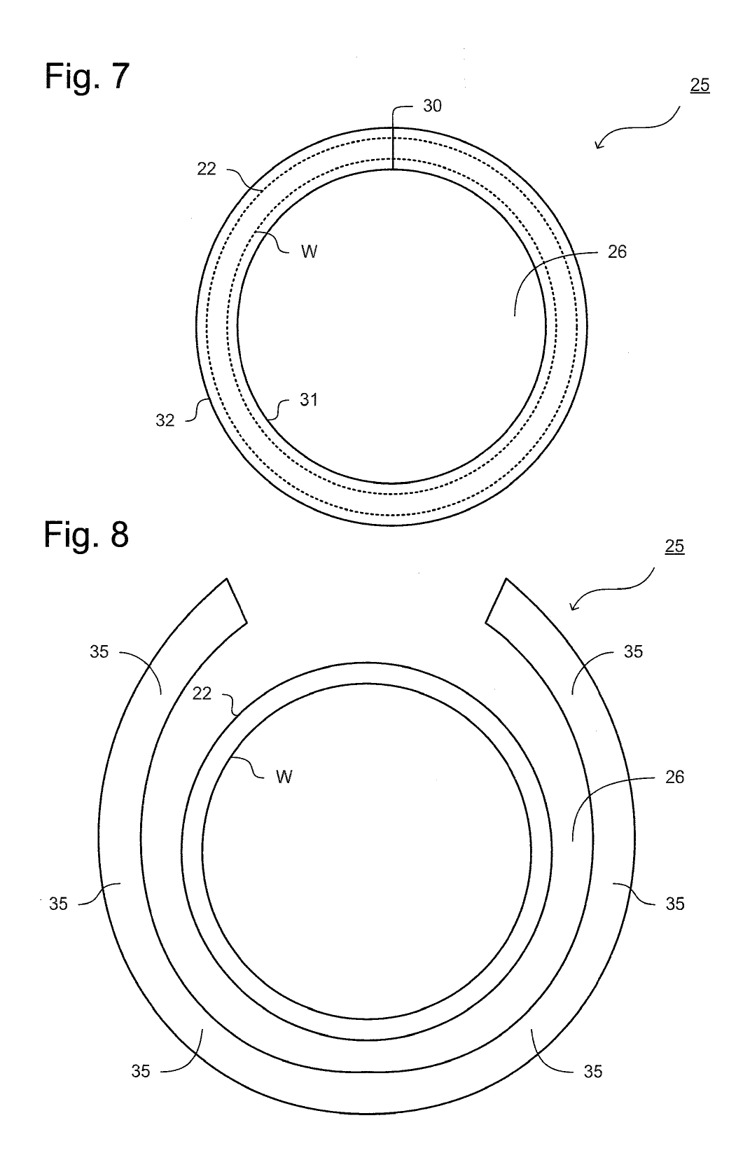

FIGS. 7 and 8 depict, in plan view, a cover 25 according to an embodiment of the invention in the closed and open positions, respectively. As shown, the cover 25 may be generally annular in shape in plan view. The inner periphery 31, e.g. circumference, of the cover 25 may define the open central section 26 of the cover 25 when it is in the closed position. A break in the generally annular shape of the cover 25 may be provided between the inner periphery, e.g., circumference, 31 and the outer periphery, e.g., circumference, 32 of the cover 25.

In an arrangement such as that depicted in FIGS. 7 and 8, the cover 25 has a plurality of portions 35 each of which are moveable by the actuator system in respective different directions. In moving the plurality of portions 35 the open central section 26 of the cover 25 may be enlarged or reduced. The plurality of portions may be combined together to form a single integral cover. However, as depicted in FIG. 8, the provision of the break 30 across the periphery, e.g., circumference, of the cover 25 may facilitate the elastic deformation of the cover 25 in order to enlarge the central open section 26.

As depicted in FIG. 8, in the open position, the open central section 26 of the cover 25 may be enlarged such that it is larger than the cross-section of the recess 22 within which the substrate W is supported. However, this need not be the case and the open central section 26 need only be sufficiently enlarged for the substrate W to pass through the open central section 26 of the cover 25.

Although the arrangement of FIGS. 7 and 8 includes a break 30 from the inner periphery 31 to the outer periphery 32 of the cover 25, this is not essential. It may be possible to sufficiently elastically deform the cover 25 using the actuator system without the break 30. This may depend on the material from which the cover 25 is formed. It may depend on the extent of the enlargement of the open central section 26 of the cover 25 that is required in order to pass the substrate W through the open central section 26.

Additional breaks may be provided in order to facilitate the enlargement, e.g., by elastic deformation, of the cover 25 in order to enlarge the open central section 26 of the cover 25 according to this aspect of the invention.

Including a single break 30 may not sufficiently reduce the instabilities in the meniscus as it crosses the gap. It may reduce the likelihood of the cover not being effective in reducing the flow of immersion liquid into the gap between the edge of the substrate W and the edge of the recess 22. It may reduce the effectiveness of the cover 25 in reducing the formation of bubbles in the immersion space on crossing the gap. The provision of at least one break 30 may significantly reduce the stresses that may be induced in the cover 25 in order to enlarge the open central section 26. This may increase the lifetime of the cover 25. In addition, this may reduce the actuation forces used to move the cover 25 to the open position. This in turn may reduce the requirements of the actuator system and reduce the heat load on the substrate table WT that may be generated by the actuator system.

The provision of any of the covers disclosed herein may have a variety of additional benefits for a substrate table within a lithographic apparatus in addition to the reduction of defects caused by bubbles and/or the reduction of bubbles, as described above.

The cleaning of the substrate table WT and the immersion system may be reduced. This, in turn, may reduce the down time of the lithographic apparatus.

A cover may reduce the transfer of contaminants from the upper surface of the substrate W to the lower surface of the substrate W. This may reduce defects that may be introduced as a result of the so-called back side contamination.

The provision of a cover covering the gap between the edge of the substrate W and the edge of the recess 22 may enable the edge of the substrate W to traverse the projection system and immersion system at a higher speed than is otherwise possible. This may increase the throughput of the lithographic apparatus.

The provision of a cover may obviate the need for an extraction system in order to remove immersion liquid and bubbles from the gap between the edge of the substrate W and the edge of the recess 22. This may reduce the heat load applied to the substrate table WT. The thermal stability of the substrate table WT may improve. The overlay accuracy of patterns formed on the substrate W may consequently improve.

An extraction system for the gap between the edge of the substrate W and the edge of the recess 22 may be a two-phase extractor. This type of extractor may produce flow induced vibrations. Therefore, the provision of a cover, which may result in such an extractor being obsolete (not being required), may reduce the vibrations within the substrate table WT.

The provision of a cover may result in a simpler system overall than a system that uses an extractor for the gap between the edge of the substrate W and the edge of the recess 22, as disclosed above. The provision of a cover over the gap 23 may reduce the cost of goods of the apparatus as a whole.

It should be appreciated that the provision of a cover according to an aspect of the invention may eliminate the need for an extraction system at the gap between the edge of the substrate W and the edge of the recess 22, as discussed above. However, a cover according to an aspect of the present invention may be used in conjunction with an extraction system. The benefits discussed above may still apply because the requirements of the extraction system may be reduced.

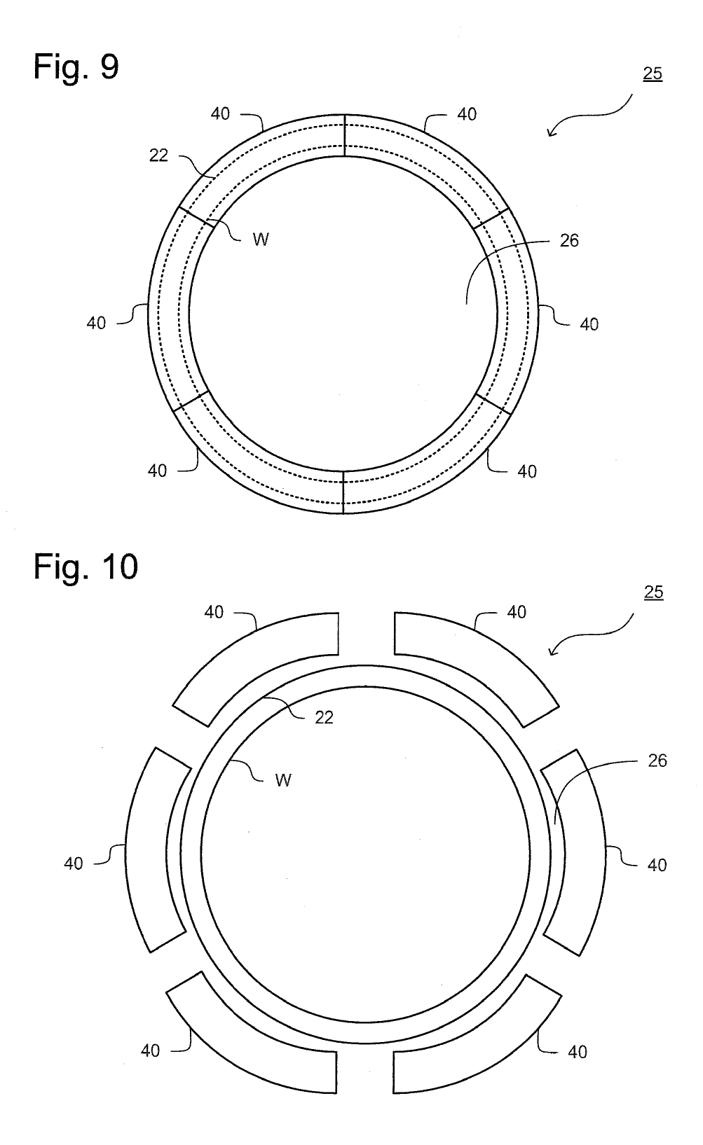

FIGS. 9 and 10 depict, in plan view, an arrangement of a cover 25 according to an embodiment of the invention. The cover depicted in FIGS. 9 and 10 is similar to the cover depicted in FIGS. 7 and 8 and, for brevity, only the differences will be discussed in detail.

As shown, the cover 25 is formed from a plurality of discrete sections 40. In the closed position, the sections 40 are arranged to abut adjacent sections 40 of the cover 25 in order to fowl a single cover 25. For example, as shown in FIG. 9, for a circular substrate W, when each of the discrete sections 40 of the cover 25 abut each other in the closed position, the combination of the discrete sections 40 provides a cover 25 having a generally annular shape.

The actuator system is configured such that it can move portions of the cover 25 in different directions in order to move the cover from the closed position to the open position. In the case of a cover 25 such as that depicted in FIGS. 9 and 10, each such portion of the cover 25 is one of the discrete sections 40. The actuator system moves each of the discrete sections 40 of the cover 25 in a respective different direction.

When the cover 25 is in the open position, the discrete sections 40 of the cover 25 may be set apart from each other, providing the enlarged open central section 26 through which the substrate W may pass as described above.

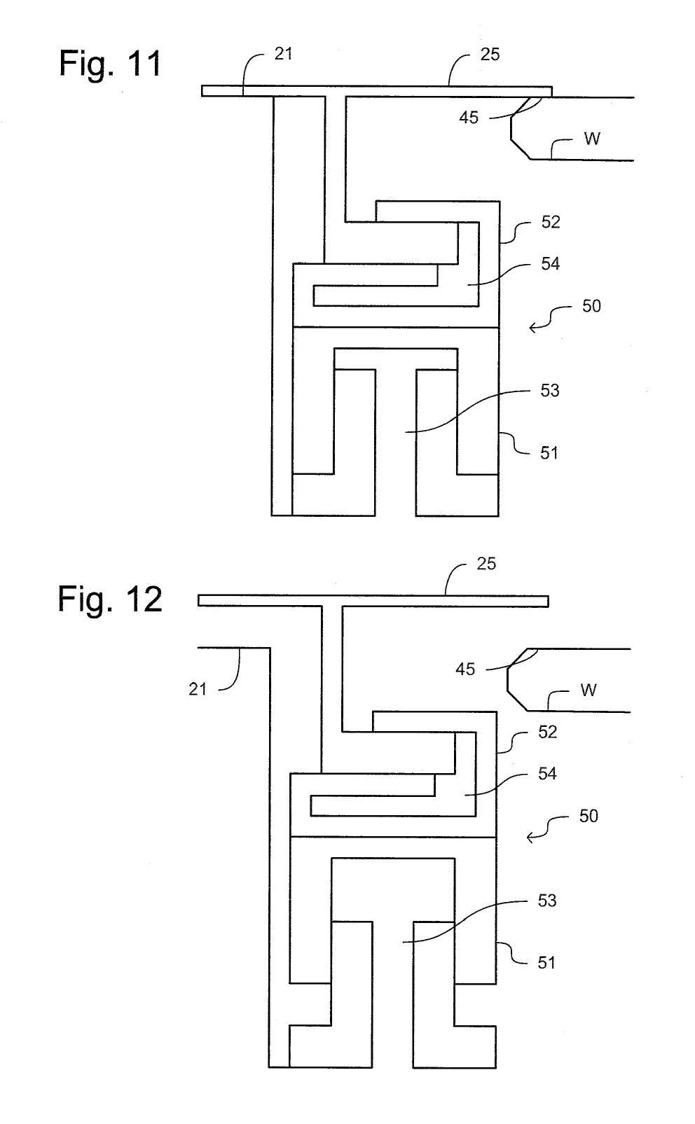

FIGS. 11, 12 and 13 depict, in cross-section, an actuator system that may be used in an aspect of the invention in, respectively, the closed position, an intermediate position and the open position.

As shown FIG. 11, in the closed position, each portion of the cover 25 is positioned on, and extends between, a peripheral portion 45 of the upper surface of the substrate W and the upper surface 21 of the substrate table WT. In moving the cover 25 from the closed position to the open position, the actuator system 50 may be configured such that each portion of the cover 25 is first moved in a direction substantially perpendicular to the upper surface of the substrate W and the upper surface 21 of the substrate table WT.

FIG. 12 depicts a portion of the cover 25 in an intermediate position between the closed and open positions after an initial movement, as described above.

In moving from the open position to the closed position, the cover 25 may be moved to the intermediate position shown in FIG. 12 such that the cover 25 may subsequently be moved to the closed position only by a movement in a direction substantially perpendicular to the upper surface of the substrate W and the upper surface 21 of the substrate table WT.

Such an arrangement may beneficially ensure that, when the cover 25 is in contact with the substrate W or close to the substrate W, the relative movement of the cover 25 to the substrate W is only in a direction that is substantially perpendicular to the upper surface of the substrate W. This may prevent or reduce the generation of contaminant particles at the edge of the substrate W. This may prevent or reduce the movement of pre-existing contaminant particles at the edge of the substrate W towards the upper surface of the substrate W on which a pattern is to be formed. On contacting the substrate by moving the cover in a direction substantially perpendicular to the surface of the substrate W, a force applied to the substrate W is applied in a direction substantially perpendicular to the substrate W. As the force is applied around the periphery of the substrate W, the force applied is substantially uniform. Distortions in the substrate W caused by the application of the force are thereby reduced, if not minimized. Forces in the plane of the substrate W by application of the cover 25 are reduced or minimized, limiting the movement of the substrate W in the recess. Position errors by applying the cover 25 to the edge of the substrate W may be reduced, if not prevented.

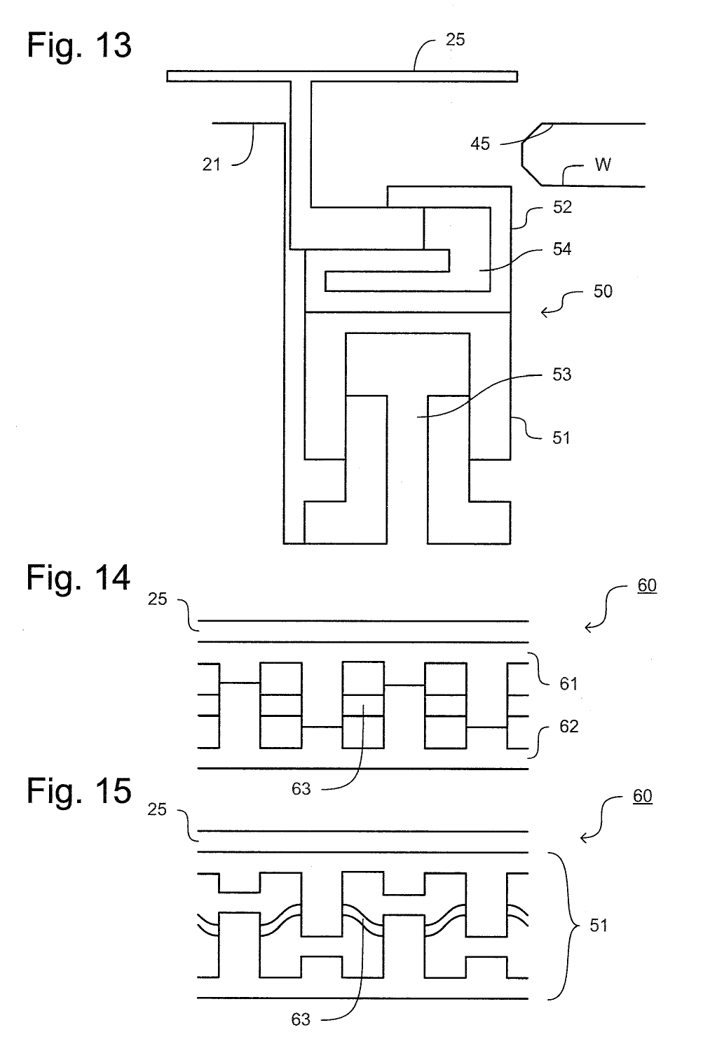

The actuator system 50 may be configured such that it can move each of the portions of the cover 25 between the intermediate position depicted in FIG. 12 and the open position depicted in FIG. 13 by moving each of the portions of the cover 25 in a direction that is substantially parallel to the upper surface of the substrate W and the upper surface 21 of the substrate table WT.

The actuator system 50 may be configured such that, in moving from the closed position to the open position, the cover 25 is first moved away from the upper surface of the substrate W and then moved such that the open central section 26 is enlarged. Likewise, the actuator system 50 may be configured such that moving from the open position to the closed position, the cover 25 is moved such that the open central section 26 is first reduced in size. Then the cover 25 is moved such that it comes into contact with the peripheral region 45 of the upper surface of the substrate W and the upper surface 21.

As shown in FIGS. 11, 12 and 13, the actuator system 50 may include an actuator stage 51 that is configured to provide movement of the cover 25 in a direction substantially perpendicular to the upper surface of the substrate W and the upper surface 21 of the substrate table WT, for example in a vertical direction. The actuator stage 51 may be referred to as a transverse actuator stage.

The actuator system 50 may include an actuator stage 52 configured to provide movement of the cover 25 in a direction substantially parallel to the upper surface of the substrate W and the upper surface 21 of the substrate table WT, for example in a horizontal direction. The actuator stage 52 may be referred to as a lateral actuator stage.

The actuator system 50 may include actuator stages 51,52 for each of the portions of the cover 25. Alternatively, for example, a single actuator stage 51 may be provided that is common for all of the portions of the cover 25.

The actuator system 50 depicted in FIGS. 11, 12 and 13 is arranged such that the actuator stages 51,52 are provided with a pneumatic actuator. Accordingly, each of the actuator stages 51,52 may be actuated by increasing or decreasing the pressure of a gas within a respective volume 53,54, that is configured to function as a cylinder of a pneumatic actuator, within the actuator stage 51,52. It should be appreciated that actuation of each stage may be positive in each direction by the provision of a gas pressure to a volume that is either greater or less than the ambient gas pressure surrounding the volume.

Alternatively or additionally, each actuator stage 51,52 may be positively actuated in one direction by means of increasing or reducing the gas pressure within a respective volume 53,54 within the actuator stage 51,52. Each actuator stage 51,52 may be returned in the opposite direction by use of a resilient element. In such an arrangement, the resilient element may bias the actuator stage 51,52 to one position. In this case the pneumatic actuator may act against the resilient element in order to move the actuator stage 51,52 to its alternative stationary/stable position.

It will be appreciated that, although the use of pneumatic actuators may be beneficial, alternative actuators may be used for one or both of the actuator stages 51, 52. For example, an electrostatic actuator and/or an electromagnetic actuator may be used.

The actuator stage 51 may be configured in order to ensure that substantially the only movement provided is in the direction substantially perpendicular to the upper surface of the substrate W and the upper surface 21 of the substrate table WT. The actuator stage 51 may include one or more movement guides. The one or more movement guides are configured to permit relative movement of the components of the actuator stage 51 in the direction substantially perpendicular to the upper surface of the substrate W and the upper surface 21 of the substrate table WT. However, the movement guide reduces or minimizes the movement of the component of the actuator stage 51 in a direction substantially parallel to the upper surface of the substrate W and the upper surface 21 of the substrate table WT.

FIGS. 14 and 15 depict, in cross-section, an arrangement of movement guides that may be used in order to help ensure that the actuator stage 51 only provides movement in a particular direction. Such a direction may be a direction substantially perpendicular to the upper surface of the substrate W and the upper surface 21 of the substrate table WT. FIG. 14 depicts a movement guide 60 when the cover 25 is in the closed position. FIG. 15 depicts the movement guide 60 when the cover 25 is in the open position.

As shown, the actuator stage 51 includes first and second components 61,62. The first and second components 61,62 may be moved relative to one another in the direction substantially perpendicular to the upper surface of the substrate W and the upper surface 21 of the substrate table WT by means of the actuator provided as described above. Elastic hinges 63 are provided between the first and second components 61,62 of the actuator stage 51. The elastic hinges permit movement of the first and second components 61,62 in a direction substantially perpendicular to the upper surface of the substrate W and the upper surface 21 of the substrate table WT. The elastic hinges are configured to restrict movement in a direction substantially perpendicular to this desired direction of movement.

It will be appreciated that an alternative or additional movement guide may be used. However, the use of one or more such elastic hinges as described above may be beneficial because this form of movement guide does not have, or desirably minimizes, frictional forces. Frictional forces may reduce the reproducibility of the force that is applied on the upper surface of the substrate W when the cover 25 is moved to the closed position.

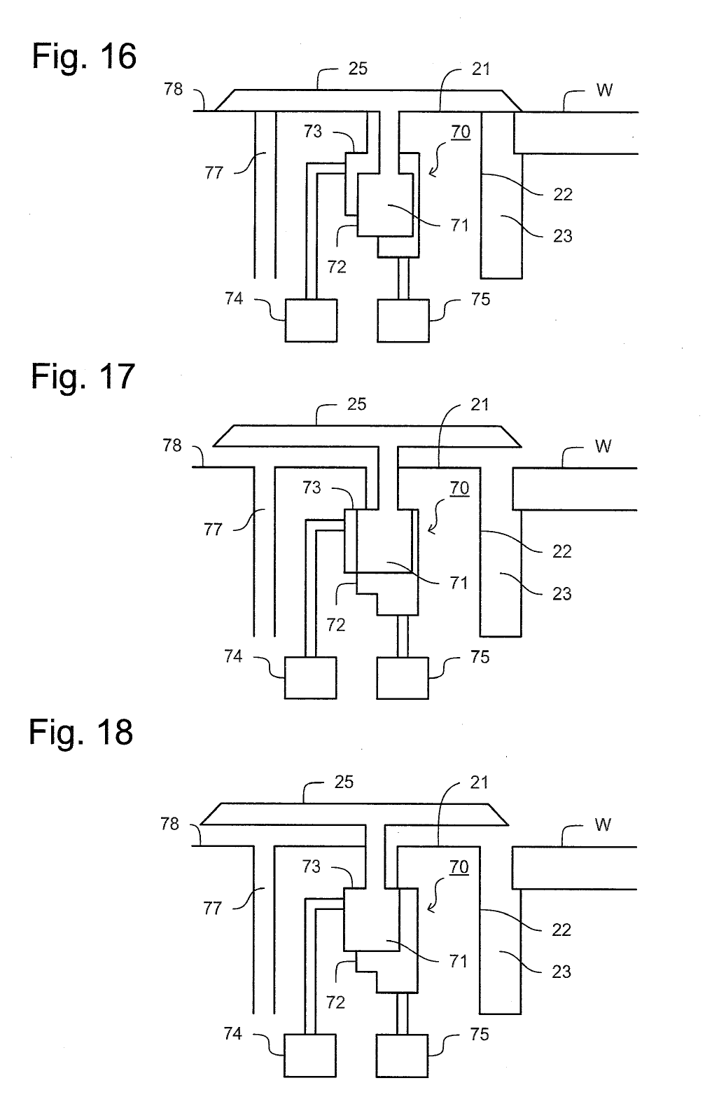

FIGS. 16, 17 and 18 depict a further actuator system that may be used with an aspect of the present invention. FIG. 16 depicts the actuator system 70 when the cover 25 is in the closed position. FIG. 17 depicts the actuator system 70 in an intermediate position. FIG. 18 depicts the actuator system 70 when the cover 25 is in the open position.

The actuator system 70 depicted in FIGS. 16, 17 and 18 may provide a simpler actuation system than that depicted in FIGS. 11, 12 and 13. Separate actuator stages are not required. Instead, each portion of the cover 25 is connected to a piston 71 that is mounted within a system of movement guides 72,73 within the substrate table WT.

A movement guide 72 may, in cooperation with the piston 71, be used to move the cover 25 from the closed position in a direction substantially perpendicular to the upper surface of the substrate W and the upper surface 21 of the substrate table WT to the intermediate position. A movement guide 73 may be arranged such that, in conjunction with the piston 71, it moves the cover 25 in a direction substantially parallel to the upper surface of the substrate W and the upper surface 21 of the substrate table WT. In order to move the cover 25 between the closed and open positions, the gas pressure on one or both sides of the piston 71 may be changed by connecting one or both of the movement guides 72,73 to an appropriate under-pressure or over-pressure source 74,75.

FIGS. 16, 17 and 18 depict an aspect of the invention that may be applied to any of the arrangements for providing a cover described within this application. The cover 25 may be configured such that in the closed position it not only covers the gap 23 between the edge of the substrate W and the edge of the recess 22 in the substrate table but it covers a further gap 77. For example, an additional gap may exist between the actuator system and a part of the substrate table further away from the substrate holder such as an additional component 78. The additional component 78 may be a component of a sensor system used in order to monitor the position and/or displacement of the substrate table WT relative to the projection system.

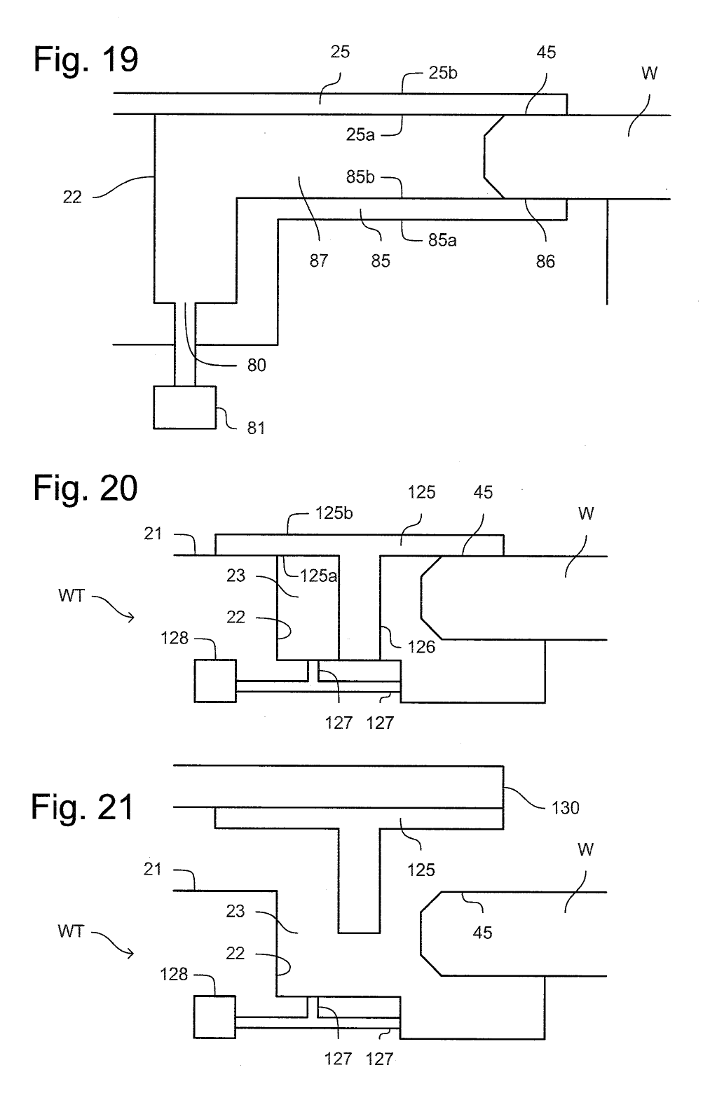

As depicted in FIG. 19, an opening 80 may be formed in the surface of the recess. The opening 80 may be a gas outlet which is connected to an under-pressure source 81. This gas outlet 80 may be arranged such that the pressure on a lower side 25a of the cover 25 is lower than the pressure on an upper side 25b. Operation of the gas outlet 80 may help ensure that, in the closed position, the cover 25 is secured to the peripheral area 45 of the upper surface of the substrate W.

As depicted in FIG. 19, the recess 22 in the substrate table WT may be provided with a secondary cover 85 that extends from an edge of the recess 22. The secondary cover 85 is configured such that, when a substrate W is within the recess 22, a peripheral area 86 of the lower surface of the substrate W is in contact with the secondary cover 85. A secondary cover 85 may beneficially further reduce the transfer of any immersion liquid from the upper surface of the substrate W to the lower surface of the substrate W. It will be appreciated that if, for example, a circular substrate W is used, the secondary cover 85 may be generally annular in shape. The secondary cover 85 may have the same thickness as the cover 25. It may be thicker than the cover 25. In general, the secondary cover may be between 10 microns and 100 microns.

As shown in FIG. 19, when a substrate W is in the recess 22 and the cover 25 is in the closed position, the cover 25, the edge of the recess 22, the edge of the substrate W and the secondary cover 85 may define an enclosed space 87. The secondary cover 85 may have an external side 85a which is external to the enclosed space 87 and an internal side 85b which is internal to the enclosed space 87. The external side 85a of the secondary cover 85 may be opposite the internal side 85b of the secondary cover 85 that adjoins the enclosed space 87. The enclosed space 87 may be connected to a gas outlet 80, which in turn is connected to an under-pressure source 81. The pressure in the enclosed space 87 may be less than the pressure on the external side 85a.

In such an arrangement, the secondary cover 85 may apply a force to the peripheral area 86 of the lower surface of the substrate W. In an appropriate arrangement of the cover 25 and the secondary cover 85, the forces applied to the substrate W by the cover 25 and the secondary cover 85 may be equal but in opposite directions. In such an arrangement, the net force on the periphery of the substrate W may be zero or minimized, reducing deformation of the substrate W.

FIGS. 20 and 21 depict, in cross-section, an embodiment of the invention in which a different arrangement of cover 125 is provided to cover the gap 23 between the edge of the substrate W and the edge of the recess 22 in the substrate table WT in which the substrate W is supported. In particular, a cover 125 of an embodiment of the invention may be configured to be moved away from the substrate table WT to permit loading/unloading a substrate W to/from the recess 22 in the substrate table WT. In such an arrangement it is not necessary to enlarge an open central section of the cover 125 in moving the cover 125 to the open position.

In common with the arrangements discussed above, the cover 125 is arranged in the form of a thin plate of material that surrounds the edge of the substrate W. The cover 125 extends from a peripheral area 45 of the upper surface of the substrate W to the upper surface 21 of the substrate receiving section. Openings 127 for gas outlets may be provided that are connected to an under-pressure source 128. The pressure in a space on the lower side 125a of the cover 125 may be lower than the gas pressure on the upper side 125b of the cover 125. The pressure difference may be used in order to secure the cover 125 and substantially prevent any movement of the cover 125 during use.

In order to prevent or reduce deformation of the cover 125, the cover may include one or more supports 126 that extend from the lower surface 125a of the cover 125 to the bottom of the recess 22 when the cover 125 is located on top of a substrate W in the recess 22.

In order to move the cover 125 in order to permit loading and unloading of a substrate W, a cover handling system 130 such as a robot arm may be provided. Specifically, the handling system 130 may be provided within the same compartment of a lithographic apparatus as the substrate table WT and may be configured to remove the cover 125 from the substrate table WT in order to permit loading and unloading of the substrate W. The cover handling system 130 may be specifically configured such that the movement of the cover 125 when the cover 125 is in contact with the substrate W or close to the substrate W is only in a direction that is substantially perpendicular to the upper surface of the substrate W and the upper surface 21 of the substrate table WT.

As discussed above, in embodiments of the invention, for example those depicted in FIGS. 11 to 18, an actuator system may be provided that moves the cover 25 from an open position, in which a substrate W may be loaded to the substrate table WT and/or a substrate W may be unloaded from a substrate WT, to a closed position, in which the cover 25 extends from the upper surface 21 of the substrate table WT to the periphery of the substrate W. In the closed position, the cover 25 may be in physical contact with the peripheral section of the substrate W and the upper surface 21 of the substrate table WT, in particular if the cover 25 is to form a seal. Such physical contact could result in damage of one or more of the cover 25, the substrate W and/or the upper surface 21 of the substrate table WT. Accordingly, an appropriate control system for the actuator system may be provided.

In an embodiment of the invention, a control system as schematically depicted in FIG. 27 may be provided. As depicted, a controller 150 is provided in order to control the actuator system 151 that positions the cover 25. In order to help ensure that the cover is accurately moved relative to the substrate W and/or substrate table WT, the controller 150 may use data that represents the height of the upper surface of at least the peripheral section of the substrate W relative to the upper surface 21 of the substrate table WT (or vice versa). Such data may, for example, be previously acquired in a metrology station 152, which may be part of the lithographic apparatus or part of a lithography system including the lithographic apparatus.

As depicted in FIG. 27 the data may be stored in a memory 153 until required by the controller 150. It will be appreciated, however, the data may also be provided directly to the controller 150.

Based on the data representing the height of the upper surface of the peripheral section of the substrate W relative to the upper surface 21 of the substrate table WT (or vice versa), the controller 150 may determine the position to which the cover 25 should be moved in order to provide a desired contact between the cover 25 and the upper surface of the substrate W and the upper surface 21 of the substrate table WT.

It will be appreciated that appropriate feedback mechanisms may be provided for the controller 150 to control the actuator system 151 to move the cover 25 to the desired position determined by the controller 150.

The controller 150 may be configured, for example, to help ensure that the position of the cover 25 in the closed position is sufficiently close to or in contact with the upper surface of the peripheral section of the substrate W to prevent, reduce or minimize leakage of the immersion liquid. Alternatively or additionally, the controller 150 may be configured to help ensure that, when the cover 25 is in the closed position, the force exerted on the upper surface of the peripheral section of the substrate W by the lower surface of the cover 25 is within a given range. For example, it may be desirable to ensure that the force is less than a certain value in order to prevent or reduce the likelihood of damage to the substrate W. Alternatively or additionally, it may be desirable to ensure that the force exerted on the upper surface of the peripheral section of the substrate W by the lower surface of the cover 25 exceeds a certain value in order to ensure that sufficient contact is made in order to control the leakage of immersion liquid below the cover 25.

In an embodiment of the invention, the data representing the height of the upper surface of the peripheral section of the substrate W relative to the upper surface 21 of the substrate table WT (or vice versa) may provide data for the relative height at a plurality of locations around the peripheral section of the substrate W. From such data, the controller 150 may be able to determine the desired position of respective portions of the cover 25 at a plurality of locations around the edge of the substrate W.

In an embodiment of the invention, the actuator system 151 may be correspondingly configured to be able to adjust the height of the cover 25 independently at a plurality of locations around the cover 25. In such an arrangement, local variations of the height of the upper surface of the substrate W and/or substrate table WT may be taken into account in controlling the positioning of the cover 25 in the closed position. This may in turn assist in preventing or reducing immersion liquid leakage and/or damage to the substrate W, the substrate table WT and/or the cover 25.

As identified above, when the cover 25 is moved to the closed position, it may exert a force on the upper surface of the peripheral section of the substrate W. It should be appreciated that this force may be exerted regardless of the arrangement of the control system for the actuator system used to move the cover 25. The force exerted on the substrate W may be sufficient to cause a movement of the upper surface of the substrate W, for example due to deformation of the substrate and/or due to deformation of the support section of the substrate table WT that supports the substrate W. Such movement of the upper surface of the substrate W may be undesirable because it may result in errors in the pattern formed on the substrate W.

In an embodiment of the invention, the cover 25 may be provided with a region that is relatively flexible, namely has a lower stiffness than the remainder of the cover. Such a relatively flexible section may be configured such that, when the cover 25 is moved to the closed position, any forces exerted on the cover and/or any inaccuracies in the positioning of the cover relative to the substrate W and/or substrate table WT results in a deformation of the relatively flexible section of the cover rather than a deformation of the substrate W or the support section of the substrate table WT that supports the substrate.

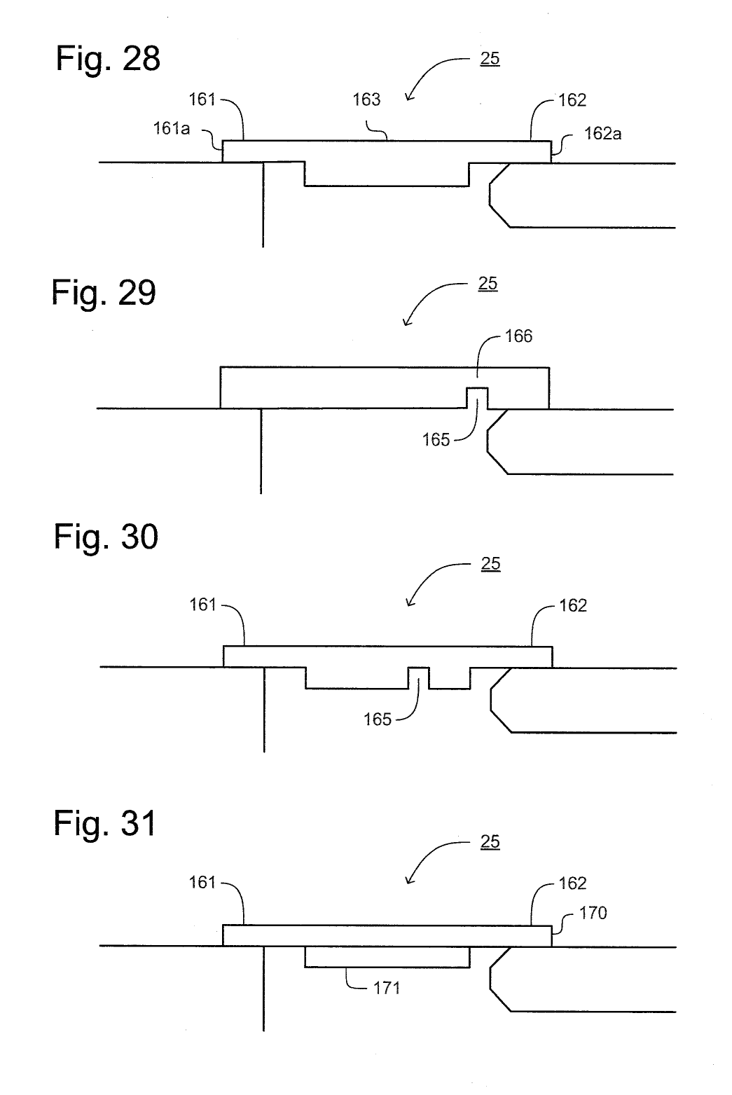

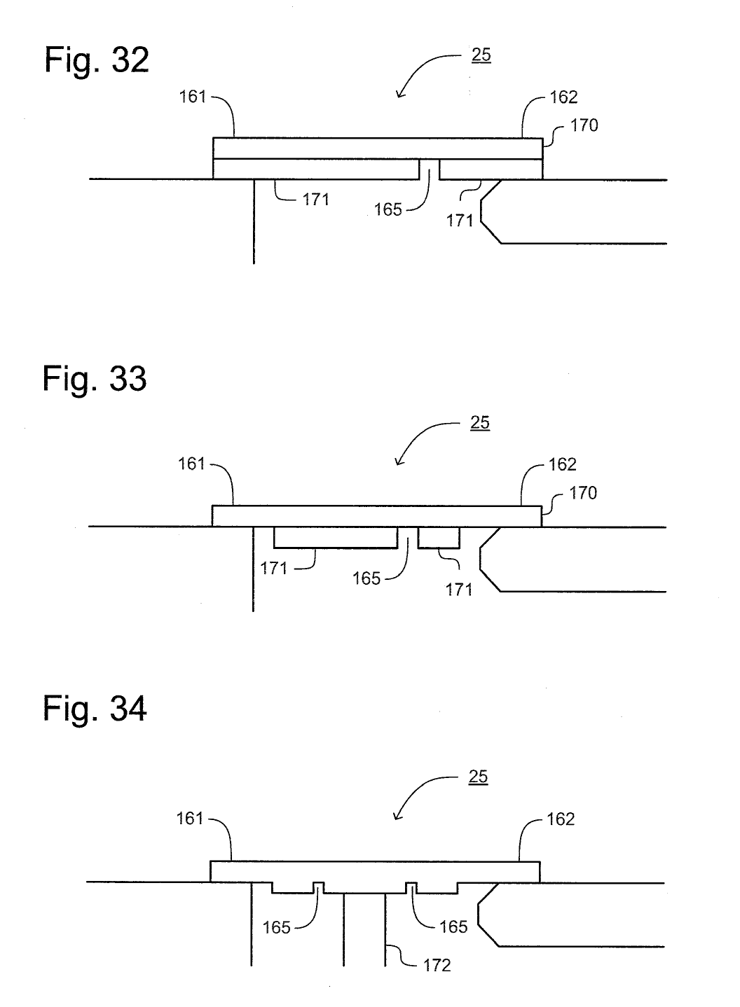

FIGS. 28 to 32 depict schematically, in cross-section, arrangements of covers 25 of an embodiment of the present invention having relatively flexible sections. As shown in FIGS. 28 to 30, a cover 25 may be formed from a single section of material and one or more relatively flexible sections may be provided in which the thickness of the cover is reduced. For example, as depicted in FIG. 28, one or more of the edge sections 161,162 of the cover 25 may have smaller thickness than the thickness of the remainder 163 of the main body of the cover 25. The sections 161,162 of reduced thickness will accordingly be less stiff than the remainder 163 of the main body of the cover 25.

The sections 161,162 of reduced thickness of the cover 25 may extend around the cover 25, for example along the entirety of the inside and/or outside edge of the cover 25. It will also be appreciated that in some arrangements, only one edge of the cover 25 will have a section of reduced thickness in order to provide a relatively flexible section.

It will be appreciated that such arrangements may be combined with embodiments discussed above in which the edge of the cover 25 is tapered. In this case, it will be appreciated that the edges 161a, 162a of the reduced thickness sections 161, 162 may be tapered. Similarly, the edges of the covers depicted in FIGS. 29 to 34, described below may be tapered. However, for brevity, this is not discussed in detail for each embodiment discussed below.

As depicted in FIG. 29, a relatively flexible section of the cover 25 may be provided by the formation of a groove 165 in the lower surface of the cover 25. The groove 165 results in an associated portion 166 of the cover 25 that has a reduced thickness and therefore reduced stiffness. It will be appreciated that the groove 165 may extend around the cover 25. Accordingly, in use, the groove 165 may be positioned above the gap between the edge of the substrate W and the edge of the recess in the substrate table WT, extending around the full periphery of the substrate.

Although FIG. 29 depicts an arrangement in which a single groove 165 is provided in the lower surface of the cover 25, it will be appreciated that a plurality of grooves may be provided in order to increase the flexibility of a section of the cover 25. However, in general, it is desirable to retain sufficient sections of the main body of the cover 25 with relatively high stiffness, namely sections of the cover having the full thickness, in order to help ensure that the cover 25 does not deform excessively in use.

As depicted in FIG. 30, the arrangements depicted in FIGS. 28 and 29 may be combined. In other words, a cover 25 may have a section of reduced thickness 161,162 at one or more of the edges of the cover 25 and may also be provided with one or more grooves 165 on the lower surface of the cover 25.

In corresponding further arrangements, as depicted in FIGS. 31 to 33 respectively, the main body of the cover 25 may be formed from a planar section of material 170 attached to at least one support section of material 171. The combination of the planar section of material 170 and the support section of material 171 provides sections of the main body of the cover 25 having full thickness and, accordingly, relatively high stiffness. Sections of the main body of the cover 25 that are formed from the planar material 170 that is not supported by support sections of material 171 provide sections of the cover 25 of reduced thickness 161,162 that have relatively low stiffness. Likewise, gaps between two support sections of material 171 provide grooves 165 that provide relatively flexible sections of the cover 25.

Although not depicted in FIGS. 28 to 33, it will be appreciated that the covers 25 of this aspect of the invention may include supports such as those discussed above, including supports to connect the cover 25 to an actuator system.

FIG. 34 depicts an embodiment of the present invention, in which the main body of the cover 25 is supported by one or more supports 172. As shown, the cover 25 has a reduced thickness section 161,162 at either edge of the cover 25, providing relatively flexible sections of the cover 25. In addition, grooves 165 are provided in the lower surface of the cover 25. The grooves 165 are positioned such that they each extend around the cover 25 in a position between a respective edge of the cover 25 and the position of the one or more supports 172. Accordingly, the grooves 165 provide additional relatively flexible sections of the cover 25. It will be appreciated that in variations of this arrangement, one or more of the relatively flexible sections of the cover 25 may be omitted.

In an embodiment of the invention, the support section of the substrate table WT that supports the substrate in the recess 22 may be configured in order to compensate for forces exerted on the substrate W by the cover 25.

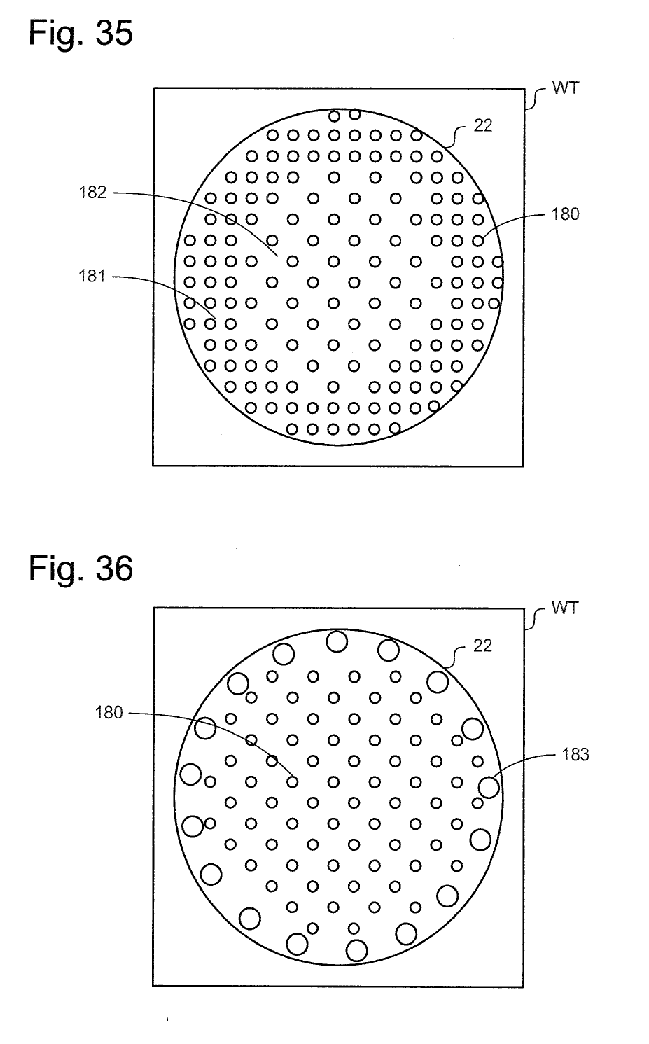

In a support section to support a substrate W on a substrate table WT, a plurality of protrusions 180 may be provided, as depicted in FIGS. 35 and 36. The protrusions 180 are arranged to support the lower surface of the substrate W at a plurality of discrete locations. Accordingly, each protrusion 180 bears a portion of the force exerted on the substrate table WT by the substrate W.

In the case of a substrate W on which a force is exerted on the peripheral section of the substrate W by a cover 25, as discussed above, the distribution of forces exerted by the substrate W on the substrate table WT may be uneven. In particular, the substrate W may exert a greater force on the protrusions 180 supporting the peripheral section of the substrate W than on the protrusions 180 supporting the central section of the substrate.

As depicted in FIG. 35, in an embodiment of the invention, the substrate table WT may be configured such that the number of protrusions 180 per unit area of the support section is greater in a peripheral region 181 of the support section of the substrate table WT than in a central section 182 of the support section of the substrate table WT.

In an embodiment, the distribution of the density of the protrusions 180, namely the number per unit area, may be selected such that, for a force that it is expected to be applied to a substrate W by a cover 25, the distribution of force is such that the force exerted on each protrusion 180 is substantially the same for both the peripheral section 181 of the support section of the substrate table WT and the central section 182 of the support section of the substrate table WT. By ensuring that the forces on each of the protrusions 180 is substantially the same, the deformation of each of the protrusions 180, in use, may be the same. This may prevent an uneven pattern of distortion of the protrusions 180, which may, for example, result in a deformation of the substrate W. For example, if the protrusions 180 in the peripheral section 181 of the support section of the substrate table WT are deformed more than the protrusions 180 in the central section 182 of the support section of the substrate table WT, an edge of the substrate W may be deformed relative to the central section of the substrate W.

FIG. 36 depicts a further arrangement of a support section of a substrate table WT for use with a cover 25. As shown, instead of increasing the number of protrusions 180 per unit area of the support section in the peripheral region, the width of the protrusions 183 in the peripheral region are increased relative to the width of the protrusions 180 in the central region of the support section of the substrate table WT. Accordingly, the wider protrusions 183 in the peripheral region may support a greater force than the narrower protrusions 180 in the central region, for a given allowable deformation.

As with the arrangement in FIG. 35, the support section depicted in FIG. 36 may be configured such that, for a given distribution of forces exerted on the support section by the substrate W, a consistent deformation of the protrusions 180, 183 is provided, reducing the deformation of the substrate W.

It will be appreciated that a combination of the arrangements depicted in FIGS. 35 and 36 may be used. Accordingly, in the peripheral region of the support section of the substrate table WT, a greater number of protrusions may be provided per unit area and each protrusion may have a greater width in comparison to the protrusions provided in a central region of the support section of the substrate table WT.

During use of a lithographic apparatus having a cover 25 such as discussed above, the condition of the cover 25 may deteriorate over time. For example, the shape of the cover 25 may be deformed due to forces exerted on it. Alternatively or additionally, contaminants may be deposited on the surface of the cover 25. Alternatively or additionally, a coating on the cover 25 may become damaged or degraded.

In an embodiment, the cover 25 of any of the arrangements discussed above may be connected to the one or more supports that support it by a releasable connection. Accordingly, the cover 25 may be replaced. In particular, the cover 25 may be replaced with a new cover. A cover 25 that has been removed may be discarded. Alternatively, the cover 25 may be cleaned and/or re-coated and/or repaired, as necessary for re-use. In general, it is expected that, when a cover 25 is removed from a lithographic apparatus, a different cover 25 will be put in its place even if the removed cover 25 is to be later re-used. This may reduce the downtime of the lithographic apparatus.

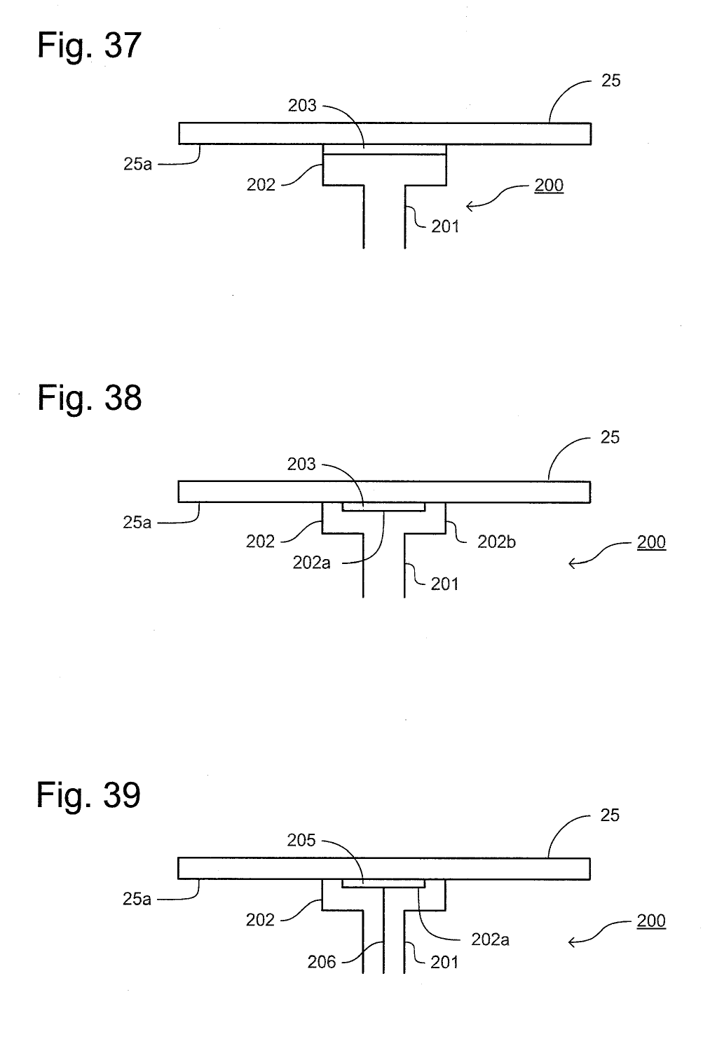

FIG. 37 depicts an embodiment of a releasable connection of an embodiment of the present invention. As shown, a support 200 to support the cover 25 may include a support column 201 and a supporting section 202. Other general configurations of support may be used. It will be appreciated that the support 200 may be connected to an actuator system as discussed above. Alternatively, the support 200 may function as a support that extends to the bottom surface of the recess 22 in an arrangement as depicted in FIGS. 20 and 21 discussed above.

As shown, the cover 25 may be connected to the support section 202 of the support 200 by means of an adhesive layer 203. In a variation of this arrangement, in place of a simple adhesive layer 203, a so-called double-sided sticker may be provided. A double-sided sticker may be formed from, for example, a substrate of a plastic material or polymer that supports an upper and a lower surface coated with adhesive.

A double-sided sticker may be prepared in advance with the appropriate dimensions to fit on the support section 202 of the support 200. Accordingly, the double-sided sticker may be attached to the support section 202 by means of the adhesive on one side of the double-sided sticker and connected to the cover 25 by means of the adhesive on the other side of the double-sided sticker. Accordingly, connection of the cover 25 to the support 200 may be facilitated, reducing the time required to form the connection.

A layer of adhesive 203 may have a thickness of, for example, approximately 5 to 50 μm. A double-sided sticker may have a thickness, for example, of from about 50 to 500 μm. Accordingly, the size of the support 200 may be selected to take into account the thickness of the layer of adhesive 203 and/or the double-sided sticker in order to ensure that the cover 25 is provided in the correct position.

FIG. 38 depicts a further arrangement to connect a cover 25 to a support 200. As shown, the support section 202 of the support 200 may include a recess 202a in which the layer of adhesive 203 or the double-sided sticker may be provided. The provision of the recess 202a may facilitate the provision of a layer of adhesive 203 by providing a defined region in which to provide the adhesive 203.

The provision of a recess 202 may further enable the cover 25 to be positioned accurately. In particular, the position of the cover 25 relative to the support 200 may be defined by the non-recessed section 202b of the support section 202 of the support 200. This may provide greater accuracy, for example, than an arrangement such as that depicted in FIG. 37 in which the cover 25 is connected to the support section 202 of the support by a layer of adhesive 203 or a double-sided sticker and in which the support section 202 does not include a recess. In such an arrangement, there may be a small variation in the position of the cover 25 relative to the support 200 due to any compressibility of the layer of adhesive 203 and/or the double-sided sticker.

It will be appreciated that alternatively or additionally, a recess to which a layer of adhesive 203 and/or a double-sided sticker may be provided may be formed on the lower side of the cover 25.

As discussed above, a cover 25 may be provided with a coating on the lower surface 25a of the cover 25. However, depending on the nature of the coating, it may not have good adhesive properties. For example, the strength of a connection between a layer of adhesive 203 or a double-sided sticker may be reduced if the adhesive or the double-sided sticker is connected to the coating.

In an arrangement, the cover 25 may be configured such that a coating is not provided in a region at which the cover 25 is to be connected to the support 200. For example, during the application of the coating to the cover 25, the relevant region may be provided with a mask that prevents the coating being applied to the region. Subsequently, the mask may be removed.

FIG. 39 depicts an embodiment of a further arrangement to connect a cover 25 to a support 200. In this arrangement, a chamber 205 is formed between the support 200 and the cover 25. The chamber 205 may be evacuated by means of a conduit 206, for example connected to an underpressure source. Accordingly, the cover 25 may be connected to the support 200 by means of a vacuum clamp.

As shown in FIG. 39, the chamber 205 may be formed by means of a recess 202a formed in the upper surface of the support section 202 of the support 200 in a similar arrangement to that depicted in FIG. 38. It will be appreciated, as with the variation of the arrangement depicted in FIG. 37, as discussed above, a recess may alternatively or additionally be formed in the lower surface of the cover 25 in order to provide the chamber 205.

In order to replace a cover 25 according to an embodiment as depicted in FIG. 39, the gas pressure in the chamber 205 may be increased, for example to atmospheric pressure, permitting removal of the cover 25 from the support 200. It will be appreciated, therefore, that an appropriate system of one or more valves and a controller may be provided to the gas conduit 206. A replacement cover 25 may then be put in place and the pressure in the chamber 205 again reduced in order to provide vacuum clamping.

It should be appreciated that the removal and replacement of the cover 25 may be performed manually and/or may be performed by a cover handling system 130 such as that discussed above.

It should be appreciated that FIGS. 37 to 39 merely schematically depict the support 200. The support 200 may have any convenient form. For example, a plurality of supports 200 may be provided distributed along the cover 25 within the gap between the edge of the substrate W and the edge of the recess 22, as discussed above. In an embodiment, the support 200 may be annular in shape.

In order to remove a cover 25 from a support 200 in which the cover 25 is connected by means of a layer of adhesive 203 or a double-sided sticker as discussed above, a force may be exerted on the cover 25 until the connection fowled by the layer of adhesive 203 or the double-sided sticker is released. In other words, a force sufficient to overcome the adhesive may be applied. After the cover 25 has been removed, any residual adhesive from the layer of adhesive 203 or the double-sided sticker may be cleaned from the support 200. Thereafter, a new cover 25 may be attached to the support 200 by means of a new layer of adhesive 203 or a new double-sided sticker.

In an embodiment of the invention, a cover 25 may be removed from the support 200 that supports the cover 25 and a new cover 25 attached to the support 200 while the support is located within the lithographic apparatus. Accordingly, a simple arrangement for replacing a cover 25 may be provided.

In an arrangement, the support 200 may be configured such that it may be removed from the lithographic apparatus while still attached to the cover 25. Accordingly, replacement of a cover 25 in a lithographic apparatus may be implemented by replacing a module that includes both the cover 25 and the support 200. Subsequently, off-line, the cover 25 may be detached from the support 200, for example in the manner discussed above, and a new or reconditioned cover 25 attached to the support 200 in order to provide a reconditioned module for use in a subsequent operation to replace a cover 25 in the lithographic apparatus or another lithographic apparatus.

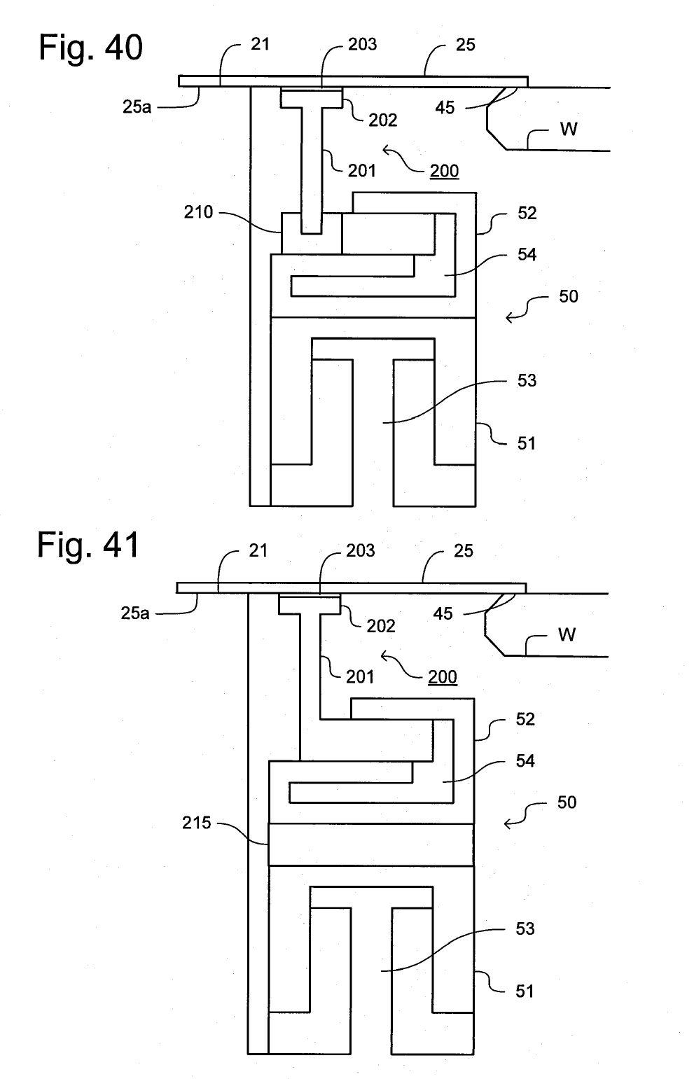

FIG. 40 depicts an arrangement of a cover 25 that may be removed with its support 200. As shown, the support 200 may be connected to the actuator system 50 that is used to control the position of the cover 25 by means of a releasable connector 210. Accordingly, when the cover 25 is to be replaced, the releasable connector 210 is released, permitting the removal of the cover 25 and the support 200. Thereafter, a replacement cover 25 may be provided by connecting its support 200 to the releasable connector 210 of the actuator system 50.

The releasable connector 210 may, for example, be formed from a mechanical clamp, for example in which the support 200 is fixed by means of a clamping force provided by a resilient member such as a spring, a magnetic clamp or a vacuum clamp. Alternative arrangements for providing a releasable connector 210 may be used.

FIG. 41 depicts an arrangement of a system permitting the removal of the cover 25 while attached to the support 200. As shown, the support 200 may be connected to a lateral actuator stage 52, as discussed above, which in turn is connected to a transverse actuator stage 51. In this arrangement, the lateral actuator stage 52 may be connected to the transverse actuator stage 51 by means of a releasable connector 215.

The releasable connector 215 used to join the two actuator stages 51, 52 may, as with the releasable connector 210 depicted in FIG. 40, be, for example, a mechanical clamp, a magnetic clamp or a vacuum clamp. Alternative arrangements for providing a releasable connector 215 may be used.

In order to remove the cover 25, the releasable connector 215 is released, permitting the removal of a module including the cover 25, the support 200 and the lateral actuator stage 52. Subsequently, a replacement module may be fitted and connected to the apparatus by the releasable connector 215. The removed module may be reconditioned off-line, as discussed above, in preparation for re-use.

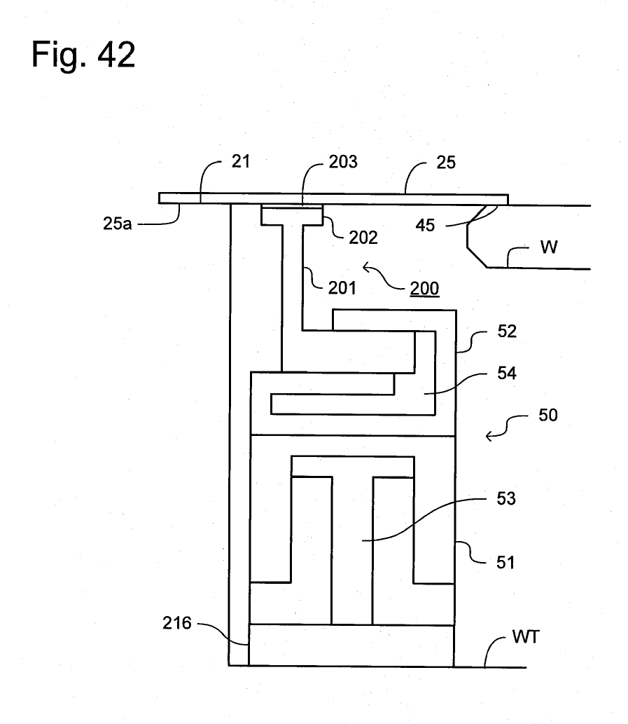

FIG. 42 depicts an arrangement of a system permitting the removal of the cover 25 while attached to the support 200. As shown, the support 200 may be connected to lateral actuator stage 52, as discussed above, which in turn is connected to a transverse actuator stage 51. In this arrangement, the combination of the lateral actuator stage 52 and the transverse actuator stage 51 may be connected to the substrate table WT by means of a releasable connector 216.

The releasable connector 216 used to join the two actuator stages 51, 52 with the substrate table WT may, as with the releaseable connectors 210, 215 depicted in FIGS. 40 and 41, be, for example, a mechanical clamp, a magnetic clamp or a vacuum clamp. Alternative arrangements for providing a releasable connector 216 may be used.

In order to remove the cover 25, the releasable connector 216 is released, permitting the removal of a module, including the cover 25, the support 200, the lateral actuator stage 52 and the transverse actuator stage 51. Subsequently, a replacement module may be fitted and connected to the apparatus by the releasable connector 216. The removed module may be reconditioned off-line, as discussed above, in preparation for re-use.

It will be appreciated that arrangements as discussed above in which the cover 25 is removed with the support 200 may have an advantage that the downtime of the lithographic apparatus in order to replace a cover 25 is reduced.

Furthermore, such an arrangement may facilitate the accurate positioning of the cover 25 relative to the support 200.

Furthermore, it will be appreciated that in arrangements in which the cover 25 is connected to the support 200 by means of a layer of adhesive 203 or a double-sided sticker and is detached from the support 200 off-line, namely in which the support 200 may be removed from the lithographic apparatus with the cover 25, greater freedom of choice of the adhesive used may be provided, either for the layer of adhesive 203 or the adhesive of the double-sided sticker. In particular, because the adhesive may be applied off-line, an adhesive with a longer drying time may be used.

For arrangements in which the support 200 and, optionally, the lateral actuator stage 52 and/or transverse actuator stage 51, is removed from the lithographic apparatus with the cover 25 for reconditioning off-line, the support 200 and, where applicable, the lateral actuator stage 52 and/or transverse actuator stage 51 may be cleaned before re-use.

In an embodiment, there is provided a cover for use in a lithographic apparatus that includes a substrate table having a substantially planar upper surface in which is formed a recess that is configured to receive and support a substrate, the cover comprising a substantially planar main body that, in use, extends around the substrate from the upper surface to a peripheral section of an upper major face of the substrate in order to cover a gap between an edge of the recess and an edge of the substrate, the cover including a relatively flexible section which, in use, extends around the substrate, the relatively flexible section configured to have lower stiffness than the remainder of the cover.

In an embodiment, the relatively flexible section of the cover comprises a region of the cover in which the thickness of the cover is smaller than the remainder of the main body of the cover. In an embodiment, the cover includes an inside edge that, in use, extends around the peripheral section of the substrate and defines an open central section of the cover, and the relatively flexible section of the cover comprises a region along the inside edge of the cover in which the thickness of the cover is smaller than the remainder of the main body of the cover. In an embodiment, the relatively flexible section of the cover comprises a groove formed in the lower surface of the cover that, in use, extends around the substrate and above the gap between the edge of the substrate and the edge of the recess. In an embodiment, the cover includes: an outside edge of the main body of the cover that, in use, extends around the recess in the upper surface of the substrate table; an inside edge of the main body of the cover that, in use, extends around the peripheral section of the substrate and defines an open central section; and a plurality of supports arranged around the lower surface of the main body of the cover, each support between the inside edge and the outside edge of a respective portion of the cover, wherein the thickness of the cover along the inside edge and/or the outside edge is smaller than the remainder of the main body of the cover, and wherein the lower surface of the cover includes a groove extending around the cover between the plurality of supports and the inside edge and/or a groove extending around the cover between the plurality of supports and the outside edge. In an embodiment, the cover further comprises an actuator system configured to move the cover between an open position, in which a substrate may be loaded into the recess and/or unloaded from the recess, and a closed position, in which the cover extends between the peripheral section of a substrate in the recess and the upper surface of the substrate table, the actuator system providing a force to the plurality of supports in order to move the cover. In an embodiment, the main body of the cover is formed from a single piece of material. In an embodiment, the cover comprises: a support section of material attached to a lower surface of a planar section of material of the main body; and a groove and/or section of the main body of the cover in which the thickness is smaller than the remainder of the main body of the cover that is provided by a region of the planar section of material that is not supported by the support section of material. In an embodiment, the main body of the cover comprises an edge having a section in which the thickness of the main body of the cover gradually increases. In an embodiment, the cover is configured such that, when the main body of the cover extends between the peripheral section of a substrate in the recess and the upper surface of the substrate table, smoothness of the upper surface of the main body of the cover is such that the peak to valley distance of the surface is less than 10 μm, desirably less than 5 μm. In an embodiment, the lower surface of the cover comprises a coating having a surface roughness R_{A} of less than 1 μm, desirably less than 200 nm, desirably less than 50 nm, desirably less than 10 nm. In an embodiment, the upper surface and/or lower surface of the cover comprises a coating that is lyophobic. In an embodiment, the upper surface of the cover comprises a coating that is resistant to damage from exposure to radiation.

In an embodiment, there is provided a substrate table for a lithographic apparatus, the substrate table having a substantially planar upper surface in which is formed a recess that is configured to receive and support a substrate, the substrate table comprising a cover as disclosed herein.

In an embodiment, there is provided a substrate table for a lithographic apparatus, the substrate table having a substantially planar upper surface in which is formed a recess that is configured to receive and support a substrate, the substrate table comprising: a cover, configured such that, in use, it extends around the substrate from the upper surface to a peripheral section of an upper major face of the substrate in order to cover a gap between an edge of the recess and an edge of the substrate; an actuator system configured to move the cover between a closed position, in which the cover is in contact with the upper surface of a substrate supported in the recess, and an open position, in which the cover is set apart from a substrate in the recess; and a controller configured to control the actuator system based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

In an embodiment, the controller is configured to determine the position of the cover necessary to provide contact between the lower surface of the cover and the upper major face of the substrate and/or the upper surface of the substrate table based on the data. In an embodiment, the controller is configured to determine, based on the data, the position of the cover necessary to ensure a contact force between the lower surface of the cover and the upper major face of the substrate is within a required range. In an embodiment, the actuator system is configured to control separately the height of the cover at a plurality of locations around the cover, the data used by the controller representing the height at a plurality of locations around the peripheral section of the substrate. In an embodiment, a main body of the cover comprises an edge having a section in which the thickness of the main body of the cover gradually increases. In an embodiment, the cover is configured such that, when the cover extends between the peripheral section of a substrate in the recess and the upper surface of the substrate table, the smoothness of the upper surface of the cover is such that the peak to valley distance of the surface is less than 10 μm, desirably less than 5 μm. In an embodiment, the lower surface of the cover comprises a coating having a surface roughness R_{A} of less than 1 μm, desirably less than 200 nm, desirably less than 50 nm, desirably less than 10 nm. In an embodiment, the upper surface and/or lower surface of the cover comprises a coating that is lyophobic. In an embodiment, the upper surface of the cover comprises a coating that is resistant to damage from exposure to radiation.

In an embodiment, there is provided a lithographic system, comprising: a substrate table as disclosed herein; and a metrology station configured to measure the height and provide data to the controller of the substrate table in order to control the actuator system that moves the cover.

In an embodiment, there is provided a substrate table for a lithographic apparatus, the substrate table having a substantially planar upper surface in which is formed a recess that is configured to receive and support a substrate, the substrate table comprising: a cover configured such that, in use, it extends around the substrate from the upper surface to a peripheral section of an upper major face of the substrate in order to cover a gap between an edge of the recess and an edge of the substrate; and a support section within the recess configured to support the substrate within the recess, the support section configured such that a stiffness of the support section supporting the peripheral section of the substrate is greater than a stiffness of the support section supporting a central region of the substrate.

In an embodiment, the relative stiffness of the support section supporting the peripheral and central regions of the substrate is selected such that, for an expected force exerted on the upper surface of the substrate by the cover, deformation of the sections of the support section supporting the peripheral and central regions of the substrate is substantially the same. In an embodiment, the support section comprises a plurality of protrusions that support the lower surface of the substrate, the number of protrusions per unit area of the support section being greater in an area supporting the peripheral section of the substrate than in an area supporting a central region of the substrate. In an embodiment, the support section comprises a plurality of protrusions that support the lower surface of the substrate, the width of protrusions in an area supporting the peripheral section of the substrate being greater than the width of protrusions in an area supporting a central region of the substrate.

In an embodiment, there is provided a lithographic apparatus comprising a substrate table as disclosed herein.

In an embodiment, there is provided a method of loading a substrate to a substrate table of a lithographic apparatus, the substrate table having a substantially planar upper surface in which is formed a recess that is configured to receive and support the substrate, the method comprising: loading a substrate to the recess; and using an actuator system to move a cover to a position in which it extends around the substrate from the upper surface of the substrate table to a peripheral section of an upper major face of the substrate in order to cover a gap between an edge of the recess and an edge of the substrate, wherein the actuator system is controlled based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

In an embodiment, the method further comprises measuring the height of the upper major face of the substrate around the peripheral section of the substrate relative to the upper surface of the substrate table or the height of the upper surface of the substrate table around the peripheral section of the substrate relative to the upper major face of the substrate around the peripheral section of the substrate, in order to provide the data.

In an embodiment, there is provided a substrate table for a lithographic apparatus, the substrate table having a substantially planar upper surface in which is formed a recess that is configured to receive and support a substrate, the substrate table comprising: a cover, configured such that, in use, it extends around the substrate from the upper surface to a peripheral section of an upper major face of the substrate in order to cover a gap between an edge of the recess and an edge of the substrate; and a support, configured to support the cover, wherein the cover is releasably attached to the support.

In an embodiment, the cover is connected to the support by a layer of adhesive, and/or a double-sided sticker, and/or a vacuum clamp. In an embodiment, the substrate table further comprises an actuator system configured to move the cover between a closed position, in which the cover is in contact with the upper surface of a substrate supported in the recess, and an open position, in which the cover is set apart from a substrate in the recess, wherein the support is connected to the actuator system by a releasable connector. In an embodiment, the substrate table further comprises an actuator system configured to move the cover between a closed position, in which the cover is in contact with the upper surface of a substrate supported in the recess, and an open position, in which the cover is set apart from a substrate in the recess, the actuator system comprising a lateral actuator stage configured to move the cover in a direction parallel to the upper major face of the substrate, and a transverse actuator stage configured to move the cover in a direction perpendicular to the upper major face of the substrate, wherein the support is connected to the lateral actuator stage and the lateral actuator stage is connected to the transverse actuator stage by a releasable connector. In an embodiment, the releasable connector comprises a mechanical clamp, and/or a magnetic clamp, and/or a vacuum clamp.

Although specific reference may be made in this text to the use of lithographic apparatus in the manufacture of ICs, it should be understood that the lithographic apparatus described herein may have other applications in manufacturing components with microscale, or even nanoscale features, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

To operate one or more movements of a component of the present invention, such as an actuator, there may be one or controllers. The controllers may have any suitable configuration for receiving, processing, and sending signals. For example, each controller may include one or more processors for executing the computer programs that include machine-readable instructions for the methods described above. The controllers may include data storage medium for storing such computer programs, and/or hardware to receive such medium.

While specific embodiments of the invention have been described above, it will be appreciated that the invention may be practiced otherwise than as explicitly described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media. The computer programs may be suitable for controlling a controller referred to herein.

One or more embodiments of the invention may be applied to any immersion lithography apparatus, in particular, but not exclusively, those types mentioned above, whether the immersion liquid is provided in the form of a bath, only on a localized surface area of the substrate, or is unconfined on the substrate and/or substrate table. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

Moreover, although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For example, it is contemplated that various combination or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

The descriptions above are intended to be illustrative, not limiting. Thus, it will be apparent to one skilled in the art that modifications may be made to the invention as described without departing from the scope of the claims set out below.

1. A cover for use in a lithographic apparatus that includes a substrate table having a substantially planar upper surface in which is formed a recess that is configured to receive and support a substrate, the cover comprising a substantially planar main body that, in use, extends around the substrate from the upper surface to a peripheral section of an upper major face of the substrate in order to cover a gap between an edge of the recess and an edge of the substrate, the cover including a relatively flexible section which, in use, extends around the substrate, the relatively flexible section configured to have lower stiffness than the remainder of the cover.

2. The cover according to claim 1, wherein the relatively flexible section of the cover comprises a region of the cover in which the thickness of the cover is smaller than the remainder of the main body of the cover.

3. The cover according to claim 1, wherein the cover includes an inside edge that, in use, extends around the peripheral section of the substrate and defines an open central section of the cover, and the relatively flexible section of the cover comprises a region along the inside edge of the cover in which the thickness of the cover is smaller than the remainder of the main body of the cover.

4. The cover according to claim 1, wherein the relatively flexible section of the cover comprises a groove formed in the lower surface of the cover that, in use, extends around the substrate and above the gap between the edge of the substrate and the edge of the recess.

5. The cover according to claim 1, wherein the cover includes:
an outside edge of the main body of the cover that, in use, extends around the recess in the upper surface of the substrate table;
an inside edge of the main body of the cover that, in use, extends around the peripheral section of the substrate and defines an open central section; and
a plurality of supports arranged around the lower surface of the main body of the cover, each support between the inside edge and the outside edge of a respective portion of the cover,
wherein the thickness of the cover along the inside edge and/or the outside edge is smaller than the remainder of the main body of the cover, and
wherein the lower surface of the cover includes a groove extending around the cover between the plurality of supports and the inside edge and/or a groove extending around the cover between the plurality of supports and the outside edge.

6. The cover according to claim 1, comprising:
a support section of material attached to a lower surface of a planar section of material of the main body; and
a groove and/or section of the main body of the cover in which the thickness is smaller than the remainder of the main body of the cover that is provided by a region of the planar section of material that is not supported by the support section of material.

7. The cover according to claim 1, wherein the main body of the cover comprises an edge having a section in which the thickness of the main body of the cover gradually increases.

8. The cover according to claim 1, wherein the cover is configured such that, when the main body of the cover extends between the peripheral section of a substrate in the recess and the upper surface of the substrate table, smoothness of the upper surface of the main body of the cover is such that the peak to valley distance of the surface is less than 10 μm.

9. The cover according to claim 1, wherein the lower surface of the cover comprises a coating having a surface roughness R_{A} of less than 1 μm.

10. The cover according to claim 1, wherein the upper surface and/or lower surface of the cover comprises a coating that is lyophobic.

11. A system, comprising:
a substrate table for a lithographic apparatus, the substrate table having a substantially planar upper surface in which is formed a recess that is configured to receive and support a substrate; and
a cover for use in a lithographic apparatus that includes a substrate table having a substantially planar upper surface in which is formed a recess that is configured to receive and support a substrate, the cover comprising a substantially planar main body that, in use, extends around the substrate from the upper surface to a peripheral section of an upper major face of the substrate in order to cover a gap between an edge of the recess and an edge of the substrate, the cover including a relatively flexible section which, in use, extends around the substrate, the relatively flexible section configured to have lower stiffness than the remainder of the cover.

12. A substrate table for a lithographic apparatus, the substrate table having a substantially planar upper surface in which is formed a recess that is configured to receive and support a substrate, the substrate table comprising:
a cover, configured such that, in use, it extends around the substrate from the upper surface to a peripheral section of an upper major face of the substrate in order to cover a gap between an edge of the recess and an edge of the substrate;
an actuator system configured to move the cover between a closed position, in which the cover is in contact with the upper surface of a substrate supported in the recess, and an open position, in which the cover is set apart from a substrate in the recess; and
a controller configured to control the actuator system based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

13. The substrate table according to claim 12, wherein the controller is configured to determine the position of the cover necessary to provide contact between the lower surface of the cover and the upper major face of the substrate and/or the upper surface of the substrate table based on the data.

14. The substrate table according to claim 12, wherein the actuator system is configured to control separately the height of the cover at a plurality of locations around the cover, the data used by the controller representing the height at a plurality of locations around the peripheral section of the substrate.

15. The substrate table according to claim 12, wherein a main body of the cover comprises an edge having a section in which the thickness of the main body of the cover gradually increases.

16. The substrate table according to claim 12, wherein the cover is configured such that, when the cover extends between the peripheral section of a substrate in the recess and the upper surface of the substrate table, the smoothness of the upper surface of the cover is such that the peak to valley distance of the surface is less than 10 μm.

17. The substrate table according to claim 12, wherein the lower surface of the cover comprises a coating having a surface roughness R_{A} of less than 1 μm.

18. The substrate table according to claim 12, wherein the upper surface and/or lower surface of the cover comprises a coating that is lyophobic.

19. A method of loading a substrate to a substrate table of a lithographic apparatus, the substrate table having a substantially planar upper surface in which is formed a recess that is configured to receive and support the substrate, the method comprising:
loading a substrate to the recess; and
using an actuator system to move a cover to a position in which it extends around the substrate from the upper surface of the substrate table to a peripheral section of an upper major face of the substrate in order to cover a gap between an edge of the recess and an edge of the substrate,
wherein the actuator system is controlled based on data representing a height of the upper major face of the substrate around the peripheral section of the substrate relative to the upper surface of the substrate table or a height of the upper surface of the substrate table around the peripheral section of the substrate relative to the upper major face of the substrate around the peripheral section of the substrate.

20. The method according to claim 19, further comprising measuring the height of the upper major face of the substrate around the peripheral section of the substrate relative to the upper surface of the substrate table or the height of the upper surface of the substrate table around the peripheral section of the substrate relative to the upper major face of the substrate around the peripheral section of the substrate, in order to provide the data.
